(19) United States
(12) Patent Application Publication
(10) Pub. No.: US 2026/0161252 A1
(43) Pub. Date: Jun. 11, 2026

(54) ELECTROSTATIC COORDINATE INPUT DEVICE AND METHOD OF DETERMINING OPERATION IN ELECTROSTATIC COORDINATE INPUT DEVICE

(71) Applicant: Alps Alpine Co., Ltd., Tokyo (JP)

(72) Inventors: Akira SATO, Miyagi-ken (JP); Satoshi NAKAJIMA, Miyagi-ken (JP)

(21) Appl. No.: 19/179,429

(22) Filed: Apr. 15, 2025

Related U.S. Application Data
(63) Continuation of application No. PCT/JP2023/034156, filed on Sep. 20, 2023.

(30) Foreign Application Priority Data
Nov. 7, 2022 (JP) 2022-178084

(51) Int. Cl. G06F 3/041; G06F 3/044

(52) U.S. Cl. CPC G06F 3/04186; G06F 3/0446; G06F 2203/04108

(57) ABSTRACT

An electrostatic coordinate input device includes an operation surface, a plurality of sensor electrodes disposed on a back side of the operation surface, a measurement circuit configured to measure a capacitance of each of the plurality of sensor electrodes, and a calculation unit configured to calculate a position of an operation body based on the plurality of capacitances measured by the measurement circuit. The calculation unit calculates a largest capacitance between the operation body and the sensor electrodes based on the plurality of capacitances, based on the largest capacitance, sets a non-pointing determination threshold value used to determine a non-pointing operation that is not a pointing operation of the operation body, and when the number of capacitances exceeding the non-pointing determination threshold value among the plurality of capacitances exceeds a determination number threshold value, determines that the operation of the operation body is the non-pointing operation.

### CLAIM OF PRIORITY

This application is a Continuation of International Application No. PCT/JP2023/034156 filed on Sep. 20, 2023, which claims benefit of Japanese Patent Application No. 2022-178084 filed on Nov. 7, 2022. The entire contents of each application noted above are hereby incorporated by reference.

### BACKGROUND OF THE INVENTION

### 1. Field of the Invention

The present disclosure relates to an electrostatic coordinate input device and a method of determining an operation in an electrostatic coordinate input device.

### 2. Description of the Related Art

A known sensor controller is connected to a matrix electrode that includes M first electrodes extending in a first direction and N second electrodes extending in a second direction. Such a sensor controller performs a finger touch detection step of supplying a predetermined signal to the M first electrodes and detecting a finger touch area indicating an area being touched by a finger by using the predetermined signal detected by the N second electrodes, and a full-range scan step of detecting an undetected stylus and calculating position coordinates of the stylus by using at least part of the M first electrodes and at least part of the N second electrodes. The sensor controller performs a sector scan step of calculating the position coordinates of the detected stylus by using a smaller number of first electrodes than the number of first electrodes used in the full-range scan step and a smaller number of second electrodes than the number of second electrodes used in the full-range scan step, a determination step of determining whether the position coordinates calculated in the sector scan step are included any of the finger touch areas detected in the finger touch detection step, and an invalidation step of invalidating the position coordinates determined to be included in the determination step. The sensor controller further performs a palm rejection step of invalidating the one or more finger touch areas detected in the finger touch detection step by performing palm rejection processing based on the size of the area. The sensor controller, in the determination step, before performing the palm rejection step, performs a step of determining whether the position coordinates calculated in the sector scan step are included any of the finger touch areas detected in the finger touch detection step (for example, see Japanese Unexamined Patent Application Publication No. 2021-168217).

Such a known sensor controller (a control unit in an input device) does not change threshold values for determining whether a touch (contact) is being performed depending on the distance between an operation surface and an operation body such as a hand. Accordingly, it is difficult to accurately determine, depending on the distance between the operation surface and the operation body such as a hand, whether an operation such as a contact operation, a proximity operation, or the like is being performed, and this may cause incorrect operations.

### SUMMARY OF THE INVENTION

The present disclosure provides an electrostatic coordinate input device capable of accurately determining, depending on the distance from an operation body, whether an operation such as a contact operation, a proximity operation, or other operations is being performed and thereby preventing incorrect operations, and a method of determining an operation in an electrostatic coordinate input device.

An electrostatic coordinate input device according to an aspect of the present disclosure includes an operation surface, a plurality of sensor electrodes disposed on a back side of the operation surface, a measurement circuit configured to measure a capacitance of each of the plurality of sensor electrodes, and a calculation unit configured to calculate a position of an operation body based on the plurality of capacitances measured by the measurement circuit. The calculation unit calculates a largest capacitance between the operation body and the sensor electrodes based on the plurality of capacitances, based on the largest capacitance, sets a non-pointing determination threshold value used to determine a non-pointing operation that is not a pointing operation of the operation body, and when the number of capacitances exceeding the non-pointing determination threshold value among the plurality of capacitances exceeds a determination number threshold value, determines that the operation of the operation body is the non-pointing operation.

### BRIEF DESCRIPTION OF THE DRAWINGS

FIG. 1 illustrates an example structure of an electrostatic coordinate input device according to an embodiment;

FIG. 2 illustrates an example structure of an electrostatic coordinate input device according to an embodiment;

FIG. 3 illustrates an example structure of an electrostatic sensor and a control device in an electrostatic coordinate input device according to an embodiment;

FIG. 4A illustrates an example of pointing operations and non-pointing operations;

FIG. 4B illustrates an example of pointing operations and non-pointing operations;

FIG. 4C illustrates an example of pointing operations and non-pointing operations;

FIG. 5 illustrates an example of threshold values for distance state determination;

FIG. 6 illustrates a summary of the distance states to be determined by an electrostatic coordinate input device according to an embodiment in relation to largest capacitances and previous distance states;

FIG. 7 is a flowchart illustrating processing to be performed by a control device in an electrostatic coordinate input device according to an embodiment;

FIG. 8 is a flowchart illustrating an example of distance state determination processing;

FIG. 9 illustrates an example of table data of threshold values to be used in non-pointing operation determination processing;

FIG. 10 is a flowchart illustrating non-pointing operation determination processing;

FIG. 11A illustrates an example of the distribution of capacitances detected by an electrostatic sensor;

FIG. 11B illustrates an example of the distribution of capacitances detected by an electrostatic sensor;

FIG. 11C illustrates an example of the distribution of capacitances detected by an electrostatic sensor;

FIG. 11D illustrates an example of the distribution of capacitances detected by an electrostatic sensor;

FIG. 12A illustrates an example operation of an electrostatic coordinate input device according to an embodiment;

FIG. 12B illustrates an example operation of an electrostatic coordinate input device according to an embodiment;

FIG. 12C illustrates an example operation of an electrostatic coordinate input device according to an embodiment;

FIG. 12D illustrates an example operation of an electrostatic coordinate input device according to an embodiment;

FIG. 12E illustrates an example operation of an electrostatic coordinate input device according to an embodiment;

FIG. 13A illustrates an example operation of an electrostatic coordinate input device according to an embodiment;

FIG. 13B illustrates an example operation of an electrostatic coordinate input device according to an embodiment;

FIG. 13C illustrates an example operation of an electrostatic coordinate input device according to an embodiment;

FIG. 13D illustrates an example operation of an electrostatic coordinate input device according to an embodiment;

FIG. 13E illustrates an example operation of an electrostatic coordinate input device according to an embodiment;

FIG. 13F illustrates an example operation of an electrostatic coordinate input device according to an embodiment;

FIG. 14A illustrates a modification of table data of threshold values to be used in non-pointing operation determination processing;

FIG. 14B illustrates a modification of table data of threshold values to be used in non-pointing operation determination processing;

FIG. 14C illustrates a modification of table data of threshold values to be used in non-pointing operation determination processing; and

FIG. 15 is a flowchart illustrating a modification of non-pointing operation determination processing.

### DESCRIPTION OF THE PREFERRED EMBODIMENTS

Hereinafter, an electrostatic coordinate input device and a method of determining an operation in an electrostatic coordinate input device according to an embodiment of the present disclosure will be described.

### <Embodiment>

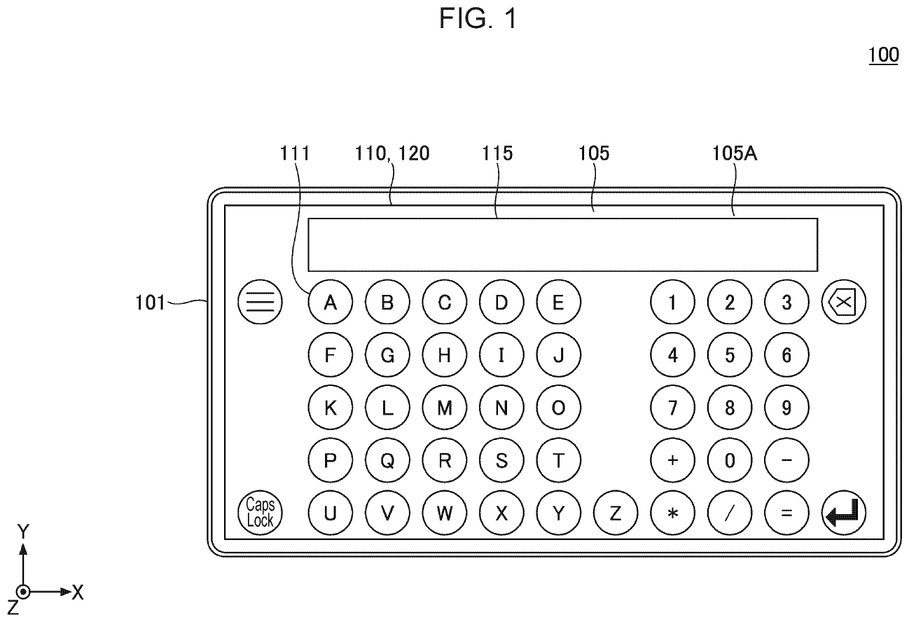

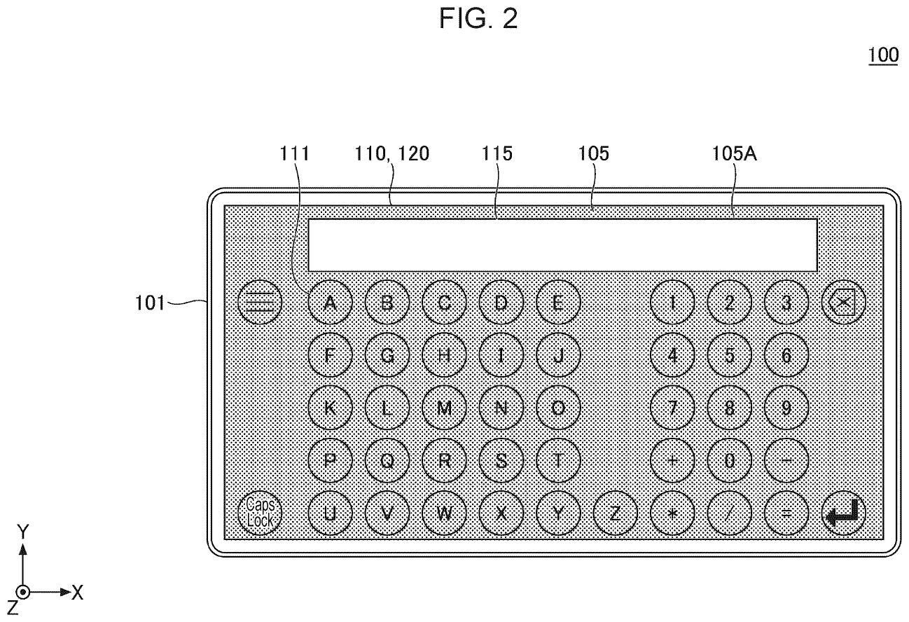

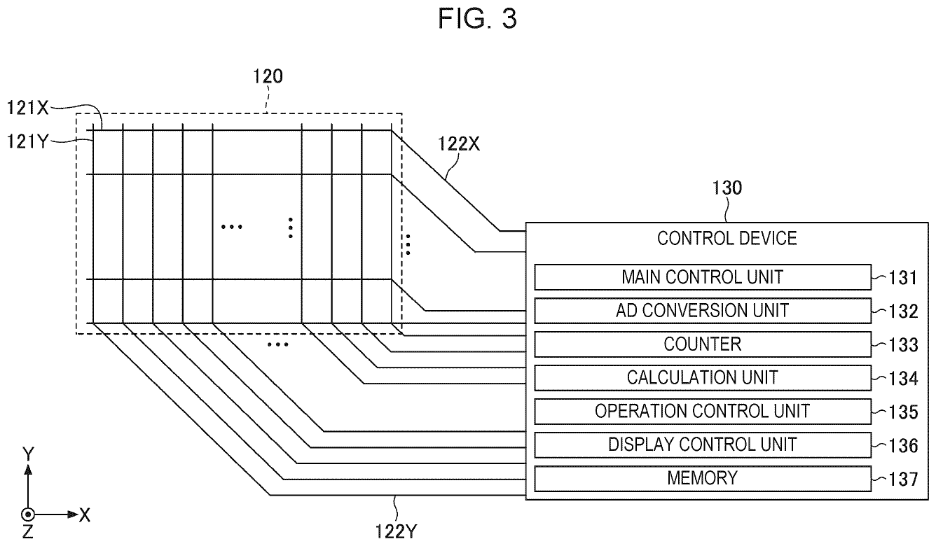

FIG. 1 and FIG. 2 illustrate an example structure of an electrostatic coordinate input device 100 according to the embodiment. The electrostatic coordinate input device 100 in FIG. 1 is in an operating state, and a display device 110 is displaying an input image. When the display device 110 is displaying the input image, the electrostatic coordinate input device 100 is in an input mode. The input mode is a mode in which an operation input can be made to the electrostatic coordinate input device 100. The electrostatic coordinate input device 100 in FIG. 2 is in a standby state, and the display device 110 is displaying a standby image. When the display device 110 is displaying the standby image, the electrostatic coordinate input device 100 is in a power saving mode. In the standby state, the display device 110 is displayed generally in gray and consumes less power. FIG. 3 illustrates an example structure of an electrostatic sensor 120 and a control device 130 in the electrostatic coordinate input device 100. The display device 110 is an example of a display section, the electrostatic sensor 120 is an example of a detection section, and the control device 130 is an example of a control section.

In the following description, an XYZ coordinate system is defined and described. A direction (X direction) parallel to the X axis, a direction (Y direction) parallel to the Y axis, and a direction (Z direction) parallel to the Z axis are mutually orthogonal to each other. In addition, in the following description, a-Z direction denotes a direction toward the electrostatic sensor 120, and a +Z direction denotes a direction away from the electrostatic sensor 120. A phrase “in plan view” refers to viewing the XY plane. In the description below, for easy understanding of the structure, the length, width, thickness, and the like of each component may be exaggerated.

The electrostatic coordinate input device 100 may be, for example, a tablet-type input device or an input unit of an automatic teller machine (ATM), which are placed in a store or a facility and used by the general public. Alternatively, the electrostatic coordinate input device 100 may be an input section of a cooking appliance that is to be kept clean. Alternatively, the electrostatic coordinate input device 100 may be a tablet computer, a smart phone, a game machine, or the like that is used individually.

### <Overall Structure of Electrostatic Coordinate Input Device 100>

The electrostatic coordinate input device 100 includes a housing 101, a top panel 105, the display device 110, the electrostatic sensor 120, and the control device 130. Although the control device 130 (see FIG. 3) is omitted in FIG. 1 and FIG. 2, the control device 130 is disposed, for example, below the display device 110 and the electrostatic sensor 120 in the housing 101. The electrostatic coordinate input device 100 includes the electrostatic sensor 120 and the control device 130 illustrated in FIG. 3.

### <Housing 101 and Top Panel 105>

The housing 101 is a case made of resin, metal, or the like and is used to accommodate the display device 110, the electrostatic sensor 120, and the control device 130. The display device 110 is disposed, for example, below the transparent electrostatic sensor 120 and is visible through an operation surface 105A, which is a top surface of the transparent top panel 105 that is disposed in an opening portion provided at a top portion of the housing 101.

### <Operation Methods of Electrostatic Coordinate Input Device 100>

The electrostatic coordinate input device 100 can be operated either in a non-contact state in which an operation body such as a hand of the user is not in contact with the operation surface 105A or in a contact state in which an operation body such as a hand of the user is in contact with the operation surface 105A.

Operation methods in the electrostatic coordinate input device 100 include four methods: a proximity operation, a selection operation, a confirmation operation, and a contact operation. Among the four operation methods, the proximity operation, the selection operation, and the confirmation operation are performed by an operation body such as a hand to the operation surface 105A in a non-contact state. The contact operation is performed in a state in which an operation body such as a hand is in contact with the operation surface 105A.

The electrostatic coordinate input device 100 distinguishes five states of the distance between an operation body such as a hand and the operation surface 105A to determine the four operation methods. These five distance states include an undetected state, a proximity state, a selection state, a confirmation state, and a contact state. The five distance states includes a contact state in which an operation body such as a hand is in contact with the operation surface 105A and a non-contact state in which an operation body such as a hand is not in contact with the operation surface 105A. The undetected state, proximity state, selection state, and confirmation state are the non-contact states.

The undetected state refers to a state in which no proximity operation, selection operation, confirmation operation, or contact operation is performed. The proximity state, the selection state, the confirmation state, and the contact state refer to states in which the proximity operation, the selection operation, the confirmation operation, and the contact operation are performed respectively. The electrostatic coordinate input device 100 uses a plurality of electrostatic capacitance threshold values to determine the operation methods. As the states change from the contact state through the confirmation state, the selection state, the proximity state, to the undetected state, the positions of an operation body such as a hand move away from the operation surface 105A.

The electrostatic coordinate input device 100 is an input device that is operated by the user by performing a pointing operation. The pointing operation is an operation performed by standing a finger approximately vertically to the operation surface 105A. The number of fingers used in the pointing operation may be more than one, but it is preferable to use one finger.

In performing such a pointing operation, when the finger is not approximately vertical to the operation surface 105A, the entire palm approaches the operation surface 105A and the value of the capacitance detected by the electrostatic coordinate input device 100 changes greatly. Accordingly, the electrostatic coordinate input device 100 determines whether the pointing operation is performed appropriately.

In the following description, an operation method in which a pointing operation is performed inappropriately, typically performed with the entire palm, is referred to as a non-pointing operation. The electrostatic coordinate input device 100 determines whether a user's operation is a pointing operation or a non-pointing operation. When a pointing operations is detected consecutively for a predetermined number of times (for example, three times), the electrostatic coordinate input device 100 determines that a pointing operation is being performed. When a non-pointing operation is detected consecutively for a predetermined number of times (for example, three times), the electrostatic coordinate input device 100 determines that a non-pointing operation is being performed. Such a determination of an operation method is performed when a pointing operation or a non-pointing operation is performed consecutively for a predetermined number of times so as to prevent incorrect determination of the operation method in the event of a sudden noise or the like. This operation method determination will be described in detail below, and here, the four operation methods are described.

In the following description, the user performs an operation with a hand H as an example operation body. In addition, in the following description, performing, with the hand H, a pointing operation or a non-pointing operation (proximity operation, selection operation, confirmation operation, or contact operation) is simply referred to as an operation (proximity operation, selection operation, confirmation operation, or contact operation) performed with the hand H.

The proximity operation refers to an operation of moving the hand H toward the operation surface 105A of the electrostatic coordinate input device 100 without touching the operation surface 105A, and is an operation to switch the electrostatic coordinate input device 100 from the standby state illustrated in FIG. 2 to the operating state illustrated in FIG. 1.

The selection operation refers to an operation of further moving the hand H toward the operation surface 105A of the electrostatic coordinate input device 100 from the state in which the proximity operation is performed without touching the operation surface 105A to select a graphic user interface (GUI) button displayed on the display device 110.

The confirmation operation refers to an operation of further moving the hand H toward the operation surface 105A of the electrostatic coordinate input device 100 from the state in which the selection operation is performed without touching the operation surface 105A to fix the operation input to the selected GUI button. The confirmation operation refers to an operation of performing a non-contact operation input, and is an operation to operate the electrostatic coordinate input device 100 in a non-contact manner without touching the operation surface 105A with the hand H. An operation input performed by the selection operation and the confirmation operation in a non-contact manner may also be referred to as hover input or touchless input.

The contact operation refers to an operation of further moving the hand H toward the operation surface 105A of the electrostatic coordinate input device 100 from the state in which the selection operation is performed to touch the operation surface 105A to fix the operation input to the selected GUI button. The contact operation may be referred to as a touch input.

### <Display Device 110>

The display device 110 is, for example, a liquid crystal display, an organic electro luminescence (EL) display, or the like. The display device 110 is a display section for implementing a GUI. The display device 110 displays images of GUI buttons 111, a cursor, and an image of an input content display section 115 that displays an input content. The GUI buttons 111 are an example of an operation section, and are arranged, for example, in a matrix state in plan view. Each of the GUI buttons 111 is, for example, round in shape to resemble a push button.

FIG. 1 to FIG. 3 illustrate, as an example, a total of 45 GUI buttons 111 including 26 alphabet GUI buttons 111, 15 GUI buttons 111 in a form of a numeric keypad, and 4 GUI buttons 111 including a Menu key (key with three lines in the top left), a Caps Lock key, a Backspace key (top right), and an Enter key (bottom right). The 45 GUI buttons 111 are arranged in 5 rows in the Y direction and 11 columns in the X direction. The rows extend in the X direction and the columns extends in the Y direction. Note that the GUI buttons 111 are not limited to the alphabetical characters, numerals for the numeric keypad, or the like, but may be characters, symbols, or the like in other languages.

Here, the example of a total of 45 GUI buttons 111 displayed by the display device 110 will be described. However, the electrostatic coordinate input device 100 may include the top panel 105 having an operation unit on which alphabetical characters, numerals, symbols, or the like are printed, instead of all or at least some of the 45 GUI buttons 111. For example, a backlight may be disposed on the back side of the top panel 105 such that light can pass through the operation unit on which alphabetical characters, numerals, symbols, or the like are printed.

When the electrostatic coordinate input device 100 is in the standby state, the backlight may be turned off, and when the electrostatic coordinate input device 100 is switched to the input mode, the backlight may be turned on to illuminate the alphabetical characters, numerals, symbols, or the like printed on the operation unit of the top panel 105. In such a case, to display an input content, a liquid crystal display, an organic EL display or the like may be provided to only the portion of the input content display section 115.

### <Electrostatic Sensor 120>

The electrostatic sensor 120 is stacked on the display device 110 and includes a plurality of sensor electrodes 121X extending in the X direction and a plurality of sensor electrodes 121Y extending in the Y direction as illustrated in FIG. 3. The sensor electrodes 121X and 121Y are an example of electrodes in the detection section, and are connected to the control device 130 via wires 122X and 122Y respectively. Such an electrostatic sensor 120 may be made by forming a transparent conductive film such as an indium tin oxide (ITO) film on the surface of a transparent glass substrate and by patterning the film as the sensor electrodes 121X and 121Y and the wires 122X and 122Y. The capacitance detected by the electrostatic sensor 120 is input to the control device 130. The capacitance detected by the electrostatic sensor 120 is an example of a detection result of the electrostatic sensor 120.

FIG. 3 illustrates, as an example, a plurality of sensor electrodes 121X and a plurality of sensor electrodes 121Y. The distance between the sensor electrodes 121X and the distance between the sensor electrodes 121Y are narrower than that between the GUI buttons 111.

The plurality of sensor electrodes 121X are scanned by one row at a time, and the plurality of sensor electrodes 121Y are scanned by one column at a time. An analog-to-digital (AD) conversion unit 132 converts the capacitances at a plurality of intersections of the plurality of sensor electrodes 121X and the plurality of sensor electrodes 121Y into digital values. A counter 133 counts a change in the output of the AD conversion unit 132 and outputs a difference value AAD at each intersection. It is also possible to increase the resolution through interpolation based on the distance between the sensor electrodes 121X and the distance between the sensor electrodes 121Y. In such a case, the distance between the sensor electrodes 121X and the distance between the sensor electrodes 121Y may be wider than the distance between the GUI buttons 111. Although not illustrated, when interpolation is applied, the GUI buttons 111 and sensor electrodes of approximately the same size as the GUI buttons 111 may be provided in a one-to-one correspondence.

The position of the hand H represented by XY coordinates detected by the electrostatic coordinate input device 100 by using the electrostatic sensor 120 is, for example, XY coordinates at which the capacitance is largest in a region in which the hand H is present. The position of the hand H in the Z direction detected by the electrostatic coordinate input device 100 by using the electrostatic sensor 120 is inversely proportional to the capacitance detected by the electrostatic sensor 120, and thus determining the position of the hand H in the Z direction is equivalent to determining the capacitance between the hand H and the electrostatic sensor 120. The electrostatic coordinate input device 100, for example, determines the position of the hand H in the Z direction based on the capacitance between the hand H and the electrostatic sensor 120; however, in the following description, when it is easier to understand to describe as the position of the hand H in the Z direction, it is described as the position of the hand H in the Z direction.

### <Control Device 130>

The control device 130 is implemented by a computer including a central processing unit (CPU), random access memory (RAM), read-only memory (ROM), an input-output interface, an internal bus, and the like.

The control device 130 includes a main control unit 131, the AD conversion unit 132, the counter 133, a calculation unit 134, an operation control unit 135, a display control unit 136, and memory 137. The main control unit 131, the AD conversion unit 132, the counter 133, the calculation unit 134, the operation control unit 135, and the display control unit 136 represent functions of a program to be implemented by the control device 130 as function blocks. The memory 137 represents the function of the memory of the control device 130.

The main control unit 131 is a processing unit that performs overall control of the processing in the control device 130, and executes processing other than the processing performed by the AD conversion unit 132, the counter 133, the calculation unit 134, the operation control unit 135, and the display control unit 136. For example, the main control unit 131 scans the plurality of sensor electrodes 121X and the plurality of sensor electrodes 121Y.

The AD conversion unit 132 converts an output of the electrostatic sensor 120 into a digital value. The output of the AD conversion unit 132 is a detection value of the capacitance at each of the intersections of the sensor electrodes 121X and the sensor electrodes 121Y in the electrostatic sensor 120. The counter 133 counts and outputs the difference value of an output of the AD conversion unit 132 with respect to a reference value. The difference value is a count value of a change in the output with respect to the reference value. Hereinafter, the difference value is referred to as a difference value AAD. The reference value is the capacitance at each of the intersections of the sensor electrodes 121X and the sensor electrodes 121Y when no finger is located around the sensor electrodes 121X and 121Y. The difference value AAD is a capacitance between each of the intersections of the sensor electrodes 121X and 121Y and a finger.

The difference value AAD can be obtained for each intersection. The AD conversion unit 132 converts a capacitance at each of the intersections of the sensor electrodes 121X and 121Y into a digital value. The counter 133 counts a change in the output of the AD conversion unit 132 with respect to a reference value and outputs a difference value AAD with respect to each intersection.

The calculation unit 134 determines, based on a difference value AAD output from the counter 133, a position of the hand H in the XY coordinates and a position of the hand H from the operation surface 105A in the Z direction. The calculation unit 134 determines a distance state between the hand H and the operation surface 105A by using a proximity capacitance threshold value, a selection capacitance threshold value, a confirmation capacitance threshold value, and a contact capacitance threshold value, which will be described below. As described above, the distance states between the hand H and the operation surface 105A include the undetected state, the proximity state, the selection state, the confirmation state, and the contact state.

The operation control unit 135 controls the operation of the electrostatic coordinate input device 100 based on a position of the hand H determined by the calculation unit 134. The display control unit 136 controls the display of the display device 110 based on a position of the hand H determined by the calculation unit 134. The memory 137 stores programs, data, and the like to be used when the main control unit 131, the calculation unit 134, the operation control unit 135, and the display control unit 136 execute processing. The memory 137 also stores data representing the number of rows and the number of columns of the sensor electrodes 121X and 121Y.

### <Pointing Operations and Non-pointing Operations>

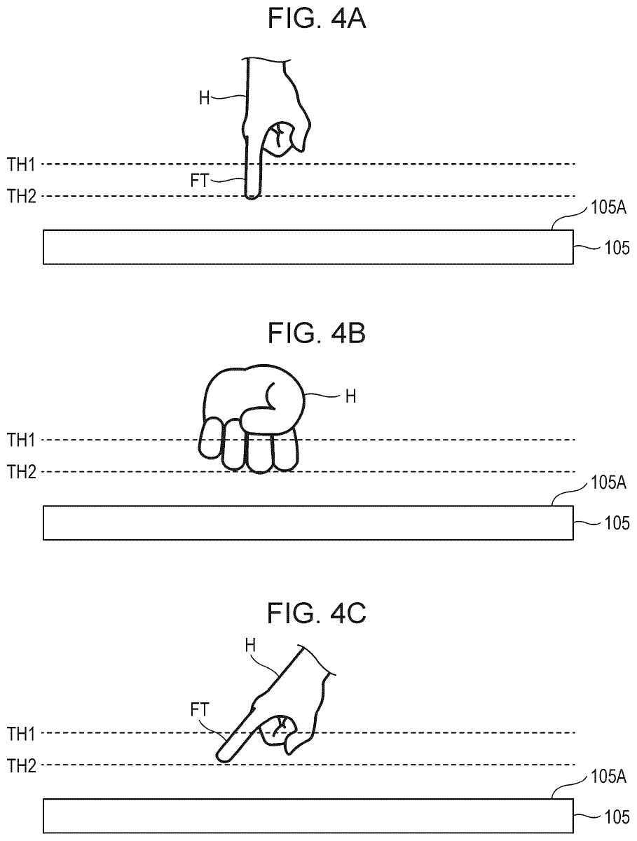

FIG. 4A to FIG. 4C illustrate examples of the pointing operations and non-pointing operations. FIG. 4A to FIG. 4C illustrate positions that correspond to a first threshold value TH1 and a second threshold value TH2 for determining the presence or the absence of the hand H by using the electrostatic sensor 120. The second threshold value TH2 is larger than the first threshold value TH1 and the position that corresponds to the second threshold value TH2 is closer to the operation surface 105A than the position that corresponds to the first threshold value TH1. Such a determination of the size of the hand H by using the first threshold value TH1 and the second threshold value TH2 is equivalent to a measurement of a cross-sectional area of the hand H.

FIG. 4A illustrates a state in which a pointing operation is being performed by moving a fingertip FT of the hand H vertically toward the operation surface 105A of the top panel 105. The electrostatic coordinate input device 100 determines, based on a projected area of the hand H from the tip of the fingertip FT of the hand H to a position away from the tip by a predetermined distance, whether a pointing operation is being performed with the fingertip FT or a non-pointing operation is being performed with the palm without extending the finger. When a pointing operations is being performed as illustrated in FIG. 4A, the electrostatic coordinate input device 100 determines that a pointing operation is being performed by the fingertip FT.

FIG. 4B illustrates a state in which a non-pointing operation is being performed by moving the hand H toward the operation surface 105A of the top panel 105 with all fingers gripped without extending them. In such a case, the projected area of the hand H increases at the position corresponding to the first threshold value TH1, and thus the electrostatic coordinate input device 100 determines that a non-pointing operation is being performed.

FIG. 4C illustrates a state in which a non-pointing operation is being performed by moving the fingertip FT of the hand H at an angle toward the operation surface 105A of the top panel 105. Although one finger is pointing the operation surface 105A, the fingertip FT is positioned at an angle with respect to the operation surface 105A and the palm is also moving toward the operation surface 105A, and thus the projected area of the hand H at the position corresponding to the first threshold value TH1 is large. Accordingly, the electrostatic coordinate input device 100 determines that a non-pointing operation is being performed.

### <Threshold Values for Distance State Determination>

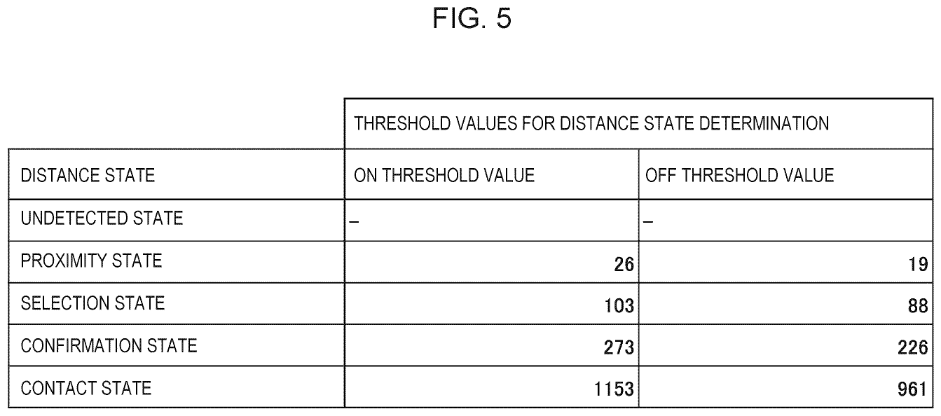

FIG. 5 illustrates an example of threshold values for distance state determination. FIG. 5 illustrates thresholds used to determine the five distance states: the undetected state, the proximity state, the selection state, the confirmation state, and the contact state.

FIG. 5 illustrates an ON threshold value and an OFF threshold value for each of the five distance states. An ON threshold value is used to determine whether a state corresponds to each distance state. When a largest capacitance detected by the electrostatic sensor 120 exceeds an ON threshold value, the distance state becomes the distance state corresponding to the ON threshold value. An OFF threshold value is used to determine whether a state does not correspond to each distance state. When a largest capacitance detected by the electrostatic sensor 120 is less than or equal to an OFF threshold value, the distance state does not correspond to the distance state corresponding to the OFF threshold value. For each distance state, an ON threshold value is set to a capacitance larger than an OFF threshold value, and hysteresis is provided to stabilize the distance state.

For the undetected state, no ON threshold value and OFF threshold value is provided. For the proximity state, the ON threshold value is 26, and the OFF threshold value is 19. For the selection state, the ON threshold value is 103, and the OFF threshold value is 88. For the confirmation state, the ON threshold value is 273, and the OFF threshold value is 226. For the contact state, the ON threshold value is 1153, and the OFF threshold value is 961. These numerical values are obtained by digitally converting capacitances detected by the electrostatic sensor 120 into count values.

These ON threshold values and the OFF threshold values are set such that the ranges between the ON threshold values and the OFF threshold values for the proximity state, the selection state, the confirmation state, and the confirmation state do not overlap each other.

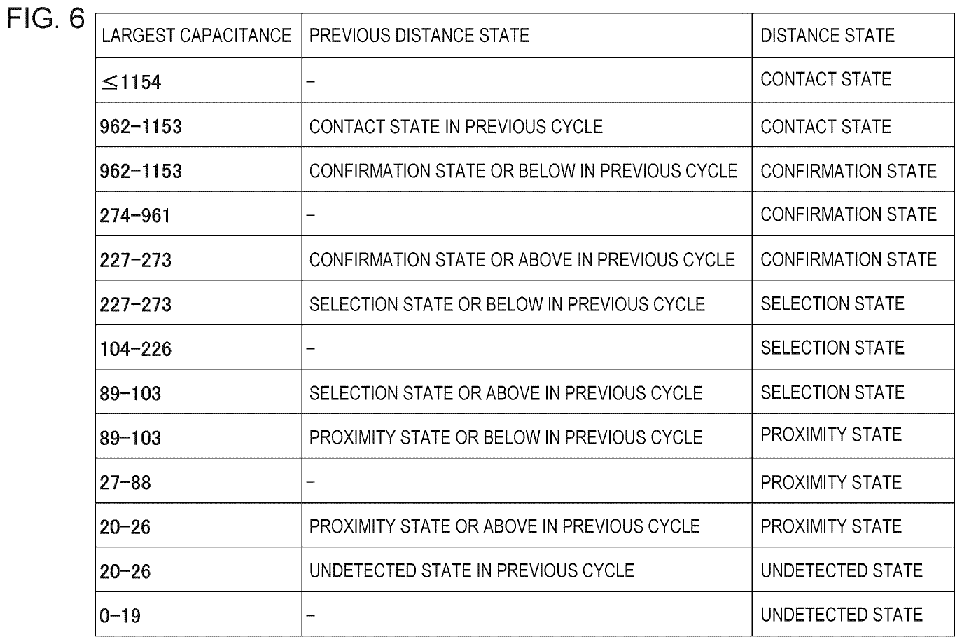

The electrostatic coordinate input device 100 determines a distance state in the current processing by using the ON threshold values and the OFF threshold values illustrated in FIG. 5, based on a distance state in the previous processing (previous control cycle). FIG. 6 summarizes the determination processing.

FIG. 6 illustrates a summary of the distance states to be determined by the electrostatic coordinate input device 100 in relation to largest capacitances and previous distance states.

As illustrated in FIG. 6, when a largest capacitance is 1154 or greater, it is determined that the current distance state is the contact state, regardless of the previous distance state.

When a largest capacitance is 962 or greater and 1153 or less, and the previous distance state is the contact state, it is determined that the current distance state is the contact state.

When a largest capacitance is 962 or greater and 1153 or less, and the previous distance state is the confirmation state or below, it is determined that the current distance state is the confirmation state. The phrase “confirmation state or below” means that the distance state is the undetected state, the proximity state, the selection state, or the confirmation state.

When a largest capacitance is 274 or greater and 961 or less, it is determined that the current distance state is the confirmation state, regardless of the previous distance state.

When a largest capacitance is 227 or greater and 273 or less, and the previous distance state is the confirmation state or above, it is determined that the current distance state is the confirmation state. The phrase “confirmation state or above” means that the distance state is the contact state or the confirmation state.

When a largest capacitance is 227 or greater and 273 or less, and the previous distance state is the selection state or below, it is determined that the current distance state is the selection state. The phrase “selection state or below” means that the distance state is the undetected state, the proximity state, or the selection state.

When a largest capacitance is 104 or greater and 226 or less, it is determined that the current distance state is the selection state, regardless of the previous distance state.

When a largest capacitance is 89 or greater and 103 or less, and the previous distance state is the selection state or above, it is determined that the current distance state is the selection state. The phrase “selection state or above” means that the distance state is the contact state, the confirmation state, or the selection state.

When a largest capacitance is 89 or greater and 103 or less, and the previous distance state is the proximity state or below, it is determined that the current distance state is the proximity state. The phrase “proximity state or below” means that the distance state is the undetected state or the proximity state.

When a largest capacitance is 27 or greater and 88 or less, it is determined that the current distance state is the proximity state, regardless of the previous distance state.

When a largest capacitance is 20 or greater and 26 or less, and the previous distance state is the proximity state or above, it is determined that the current distance state is the proximity state. The phrase “proximity state or above” means that the distance state is the contact state, the confirmation state, the selection state, or the proximity state.

When a largest capacitance is 20 or greater and 26 or less, and the previous distance state is the undetected state, it is determined that the current distance state is the undetected state.

When a largest capacitance is 0 or greater and 19 or less, it is determined that the current distance state is the undetected state, regardless of the previous distance state.

### <Overall Processing>

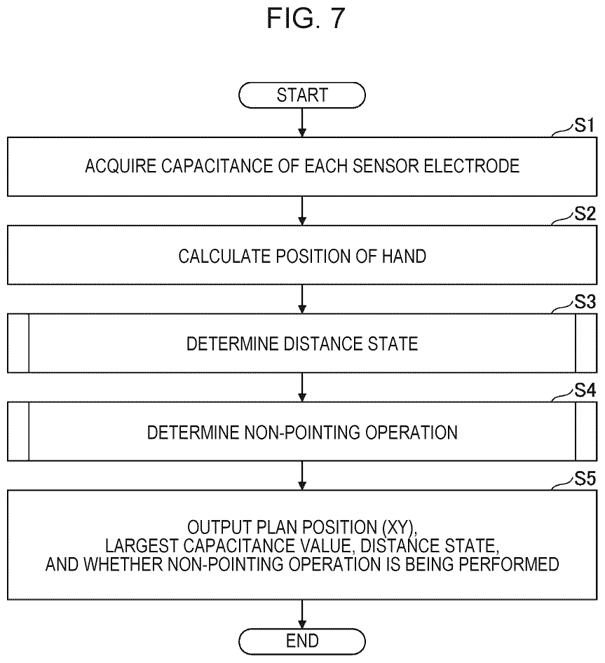

FIG. 7 is a flowchart illustrating processing to be performed by the control device 130 in the electrostatic coordinate input device 100. The flow illustrated in FIG. 7 is invoked and executed by application software, which is not illustrated. When the application software is waiting for an input, the flow in FIG. 7 is repeated from start to end in predetermined control cycles.

When the control device 130 starts the processing, the calculation unit 134 acquires a capacitance of each electrode (each electrode of the sensor electrodes 121X and 121Y) (step S1).

The calculation unit 134 calculates a position of the hand H (step S2). The position (XY coordinates) of the hand H is the position of a detection point at which the capacitance is largest among the capacitances acquired in step S1.

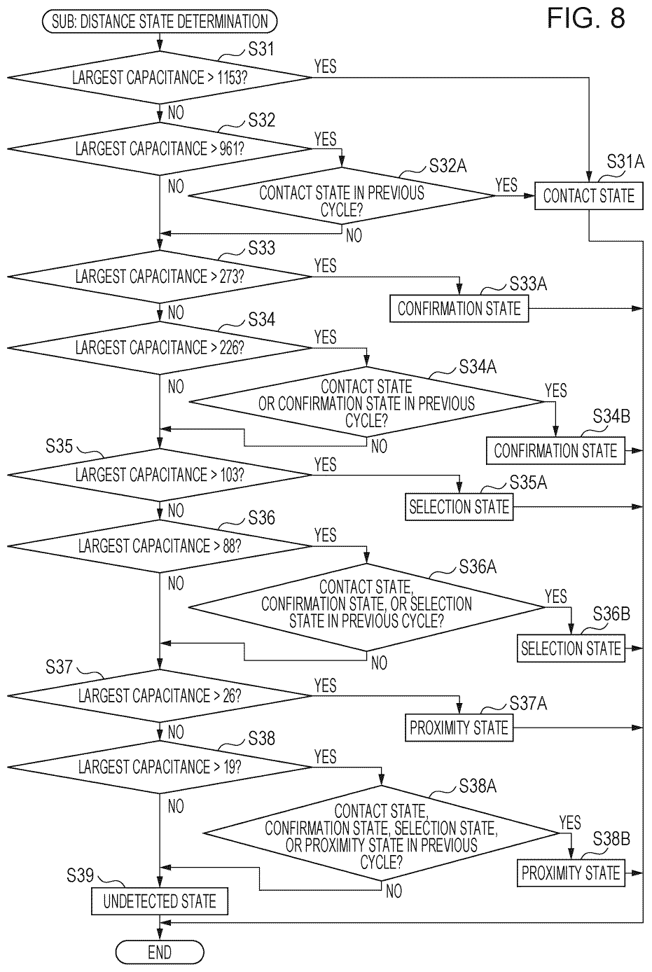

The calculation unit 134 determines a distance state between the fingertip FT and the operation surface 105A based on the largest capacitance acquired in step S2 (step S3). The process in step S3 is a subroutine process for determining a distance state and will be described below with reference to FIG. 8. The process of step S3 determines a distance state between the hand H and the operation surface 105A to one of the distance states.

The calculation unit 134 performs a non-pointing operation determination for determining whether the non-pointing operation is being performed (step S4). The process in step S4 is a subroutine process and will be described below with reference to FIG. 10. The process of step S4 determines whether the non-pointing operation is being performed by the hand H.

The calculation unit 134 outputs the position of the hand H (XY coordinates), the largest capacitance, the distance state, and data indicating whether the non-pointing operation is being performed (step S5).

When the calculation unit 134 completes the process in step S5, it ends the series of processing (END).

### <Distance State Determination Processing>

FIG. 8 is a flowchart illustrating an example of the distance state determination processing. The process illustrated in FIG. 8 is a subroutine process in step S3 in FIG. 7.

When the calculation unit 134 starts the distance state determination processing, it determines whether the largest capacitance acquired in step S2 exceeds 1153 (step S31). This process is performed to determine whether the distance state is the contact state.

When the calculation unit 134 determines that the largest capacitance exceeds 1153 (S31: Yes), it determines that the distance state is the contact state (step S31A). When the calculation unit 134 ends the process in step S31A, it ends the distance state determination processing (subroutine process), and the flow proceeds to step S4.

In step S31, when the calculation unit 134 determines that the largest capacitance does not exceed 1153 (S31: No), it determines whether the largest capacitance acquired in step S2 exceeds 961 (step S32).

When the calculation unit 134 determines that the largest capacitance exceeds 961 (S32: Yes), it determines whether the previous distance state is the contact state (step S32A).

When the calculation unit 134 determines that the previous distance state is the contact state (S32A: Yes), the flow proceeds to step S31A and the calculation unit 134 determines that the distance state is the contact state (step S31A). When the calculation unit 134 completes the process in step S31A, it ends the series of processing (END).

In step S32, when the calculation unit 134 determines that the largest capacitance acquired in step S2 does not exceed 961 (S32: No), or in step S32A, when the calculation unit 134 determines that the previous distance state is not the contact state (S32A: No), the calculation unit 134 determines whether the largest capacitance acquired in step S2 exceeds 273 (step S33).

When the calculation unit 134 determines that the largest capacitance exceeds 273 (S33: Yes), it determines that the distance state is the confirmation state (step S33A). When the calculation unit 134 completes the process in step S33A, it ends the series of processing (END).

In step S33, when the calculation unit 134 determines that the largest capacitance does not exceed 273 (S33: No), it determines whether the largest capacitance acquired in step S2 exceeds 226 (step S34).

When the calculation unit 134 determines that the largest capacitance exceeds 226 (S34: Yes), it determines that the previous distance state is the contact state or the confirmation state (step S34A).

When the calculation unit 134 determines that the previous distance state is the contact state or the confirmation state (S34A: Yes), it determines that the distance state is the confirmation state (step S34B). When the calculation unit 134 completes the process in step S34B, it ends the series of processing (END).

In step S34, when the calculation unit 134 determines that the largest capacitance does not exceed 226 (S34: No), or in step S34A, when the calculation unit 134 determines that the previous distance state is neither the contact state nor the confirmation state (S34A: No), the calculation unit 134 determines whether the largest capacitance acquired in step S2 exceeds 103 (step S35). When the previous distance state is not the confirmation state, it means that the previous distance state is the selection state or below.

When the calculation unit 134 determines that the largest capacitance exceeds 103 (S35: Yes), it determines that the distance state is the selection state (step S35A). When the calculation unit 134 completes the process in step S35A, it ends the series of processing (END).

In step S35, when the calculation unit 134 determines that the largest capacitance does not exceed 103 (S35: No), it determines whether the largest capacitance acquired in step S2 exceeds 88 (step S36).

When the calculation unit 134 determines that the largest capacitance exceeds 88 (S36: Yes), it determines that the previous distance state is the contact state, the confirmation state, or the selection state (step S36A).

When the calculation unit 134 determines that the previous distance state is the contact state, the confirmation state, or the selection state (S36A: Yes), it determines that the distance state is the selection state (step S36B). When the calculation unit 134 completes the process in step S36B, it ends the series of processing (END).

In step S36, when the calculation unit 134 determines that the largest capacitance does not exceed 88 (S36: No), or in step S36A, when the calculation unit 134 determines that the previous distance state is none of the contact state, the confirmation state, or the selection state (S36A: No), the calculation unit 134 determines whether the largest capacitance acquired in step S2 exceeds 26 (step S37). When the previous distance state is none of the contact state, the confirmation state, or the selection state, it means that the previous distance state is the proximity state or below.

When the calculation unit 134 determines that the largest capacitance exceeds 26 (S37: Yes), it determines that the distance state is the proximity state (step S37A). When the calculation unit 134 completes the process in step S37A, it ends the series of processing (END).

In step S37, when the calculation unit 134 determines that the largest capacitance does not exceed 26 (S37: No), it determines whether the largest capacitance acquired in step S2 exceeds 19 (step S38).

When the calculation unit 134 determines that the largest capacitance exceeds 19 (S38: Yes), it determines that the previous distance state is the contact state, the confirmation state, the selection state, or the proximity state (step S38A).

When the calculation unit 134 determines that the previous distance state is the proximity state (S38A: Yes), it determines that the distance state is the proximity state (step S38B). When the calculation unit 134 completes the process in step S38B, it ends the series of processing (END).

In step S38, when the calculation unit 134 determines that the largest capacitance does not exceed 19 (S38: No), or in step S38A, when it determines that the previous distance state is none of the contact state, the confirmation state, the selection state, or the proximity state (S38A: No), the calculation unit 134 determines that the distance state is the undetected state (step S39). When the calculation unit 134 completes the process in step S39, it ends the series of processing (END).

### <Non-pointing Operation Determination Processing>

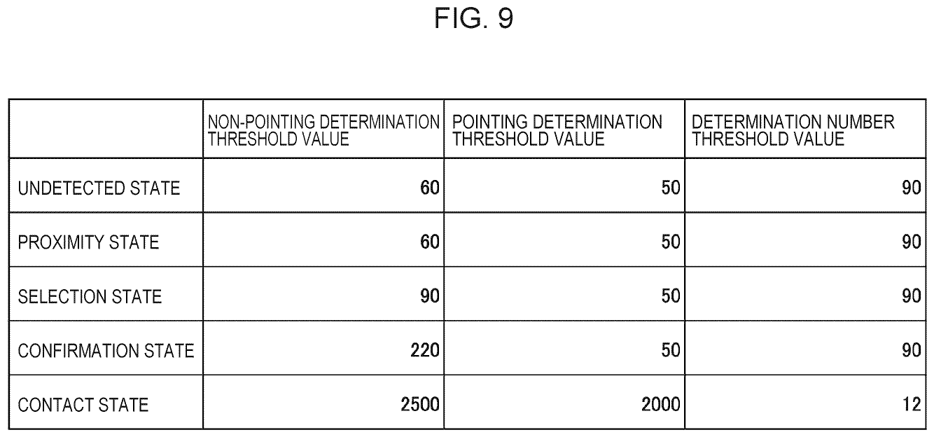

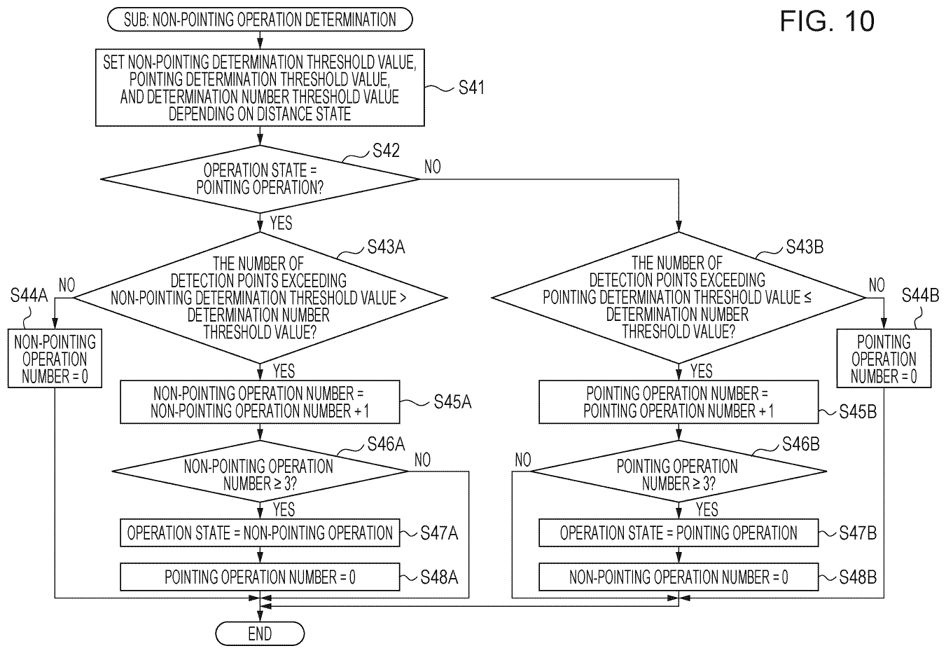

FIG. 9 illustrates an example of table data of threshold values to be used in non-pointing operation determination processing. Threshold values to be used in the non-pointing operation determination processing include a non-pointing determination threshold value, a pointing determination threshold value, and a determination number threshold value. The non-pointing determination threshold value, the pointing determination threshold value, and the determination number threshold value are provided for each of the undetected state, the proximity state, the selection state, and the confirmation state.

The non-pointing determination threshold value is used to determine whether the non-pointing operation is being performed based on a largest capacitance detected by the electrostatic sensor 120. The pointing determination threshold value is used to determine whether the pointing operation is being performed based on a largest capacitance detected by the electrostatic sensor 120. The determination number threshold value is used to determine whether the non-pointing operation or the pointing operation is being performed.

The non-pointing determination threshold value is used, in each of the undetected state, the proximity state, the selection state, the confirmation state, and the contact state, to determine whether the non-pointing operation is being performed based on a capacitance detected by the electrostatic sensor 120. When the number of detection points at which the capacitances exceed the non-pointing determination threshold value exceeds the determination number threshold value, it is determined that the non-pointing operation is being performed.

The pointing determination threshold value is used, in each of the undetected state, the proximity state, the selection state, the confirmation state, and the contact state, to determine whether the pointing operation is being performed based on a capacitance detected by the electrostatic sensor 120. When the number of detection points at which the capacitances exceed the pointing determination threshold value is less than or equal to the determination number threshold value, it is determined that the pointing operation is being performed.

The determination number threshold value is, as described above, a threshold value compared with the number of detection points at which the capacitances exceed the pointing determination threshold value in determining whether the non-pointing operation or the pointing operation is being performed. The value of the determination number threshold value represents the number of detection points of the electrostatic sensor 120.

As illustrated in FIG. 9, the non-pointing determination threshold values are set to be equal in the undetected state and the proximity state, but the values are set to increase from the undetected state and the proximity state to the selection state, the confirmation state, and the contact state as the hand H and the operation surface 105A become closer. More specifically, the non-pointing determination threshold values are set to 60 in the undetected state and the proximity state, set to 90 in the selection state, set to 220 in the confirmation state, and set to 2500 in the contact state. As described above, the non-pointing determination threshold values are set to larger values as the distances represented by a plurality of distance states become shorter.

The pointing determination threshold values are set to be equal to 50 in the undetected state, the proximity state, the selection state, and the confirmation state, and set to 2000 in the contact state.

As illustrated in FIG. 9, the non-pointing determination threshold value in the contact state is larger than the non-pointing determination threshold values in the plurality of non-contact states (undetected state, proximity state, selection state, and confirmation state). The pointing determination threshold value in the contact state is larger than the pointing determination threshold value in the plurality of non-contact states. The determination number threshold value in the contact state is smaller than the determination number threshold values in the plurality of non-contact states (undetected state, proximity state, selection state, and confirmation state).

FIG. 10 is a flowchart illustrating the non-pointing operation determination processing. The process illustrated in FIG. 10 is a subroutine process in step S4 in FIG. 7.

When the calculation unit 134 starts the non-pointing operation determining processing, it sets a non-pointing determination threshold value, a pointing determination threshold value, and a determination number threshold value, depending on the distance state, based on the table data of threshold values illustrated in FIG. 9 (step S41).

The calculation unit 134 determines whether the previous operation state is the pointing operation (step S42).

When the calculation unit 134 determines that the variable “operation state” is the “pointing operation” (S42: Yes), it determines whether the number of detection points at which the capacitances exceed the non-pointing determination threshold value exceeds the determination number threshold value (step S43A). The process in step S43A determines whether the non-pointing operation is being performed.

When the calculation unit 134 determines that the number of detection points at which the capacitances exceed the non-pointing determination threshold value does not exceed the determination number threshold value (S43A: No), the calculation unit 134 resets the non-pointing operation number to zero (step S44A). The non-pointing operation number represents the number of times the calculation unit 134 determines, by determining to be Yes in step S43A, that the non-pointing operation is being performed temporarily. When the calculation unit 134 completes the process in step S44A, it ends the series of processing (END).

In step S43A, when the calculation unit 134 determines that the number of detection points at which the capacitances exceed the non-pointing determination threshold value exceeds the determination number threshold value (S43A: Yes), the calculation unit 134 increments the non-pointing operation number (step S45A).

The calculation unit 134 determines whether the non-pointing operation number is three or greater (step S46A).

When the calculation unit 134 determines that the non-pointing operation number is not three or greater (S46A: No), it ends the series of processing (END).

In step S46A, when the calculation unit 134 determines that the non-pointing operation number is three or greater (S46A: Yes), the calculation unit 134 changes the variable “operation state” to the “non-pointing operation” (step S47A). The non-pointing operation number does not reach three times unless it is determined to be Yes in step S43A for three consecutive times.

Accordingly, for three consecutive times, in step S43A, when it is determined that the number of detection points at which the capacitances exceed the non-pointing determination threshold value exceeds the determination number threshold value (S43A: Yes), it is determined that the operation of the hand H is the non-pointing operation. In order to prevent incorrect determination of the operation method when sudden noise occurs or the like, when it is determined for three consecutive times that the number of detection points at which the capacitances exceed the non-pointing determination threshold value exceeds the determination number threshold value (S43A: Yes), it is determined that the operation of the hand H is the non-pointing operation.

The calculation unit 134 resets the pointing operation number to zero (step S48A). When the calculation unit 134 completes the process in step S48A, it ends the series of processing (END).

In step S42, when the calculation unit 134 determines that the previous operation state is not the pointing operation (S42: No), it determines whether the detection points at which the capacitances exceed the pointing determination threshold value is less than or equal to the determination number threshold value (step S43B). The process in step S43B determines whether the non-pointing operation is being performed.

When the calculation unit 134 determines that the number of detection points at which the capacitances exceed the pointing determination threshold value is not less than or equal to the determination number threshold value (S43B: No), the calculation unit 134 resets the pointing operation number to zero (step S44B). The pointing operation number represents the number of times the calculation unit 134 determines that the pointing operation is being performed temporarily by determining to be Yes in step S43B. When the calculation unit 134 completes the process in step S44B, it ends the series of processing (END).

In step S43B, when the calculation unit 134 determines that the number of detection points at which the capacitances exceed the non-pointing determination threshold value is less than or equal to the determination number threshold value (S43B: Yes), the calculation unit 134 increments the pointing operation number (step S45B).

The calculation unit 134 determines whether the pointing operation number is three or greater (step S46B).

When the calculation unit 134 determines that the pointing operation number is not three or greater (S46B: No), it ends the series of processing (END).

In step S46B, when the calculation unit 134 determines that the pointing operation number is three or greater (S46B: Yes), the calculation unit 134 changes the variable “operation state” to the “pointing operation” (step S47B). The pointing operation number does not reach three times unless it is determined to be Yes in step S43B for three consecutive times.

Accordingly, for three consecutive times, in step S43B, when it is determined that the number of detection points at which the capacitances exceed the pointing determination threshold value is less than or equal to the determination number threshold value (S43B: Yes), it is determined that the operation of the hand H is the pointing operation. In order to prevent incorrect determination of the operation method when sudden noise occurs or the like, when it is determined for three consecutive times that the number of detection points at which the capacitances exceed the pointing determination threshold value is less than or equal to the determination number threshold value (S43B: Yes), it is determined that the operation of the hand H is the pointing operation.

The calculation unit 134 resets the non-pointing operation number to zero (step S48B). When the calculation unit 134 completes the process in step S48B, it ends the series of processing (END).

### <Distribution of Capacitances Detected by Electrostatic Sensor 120>

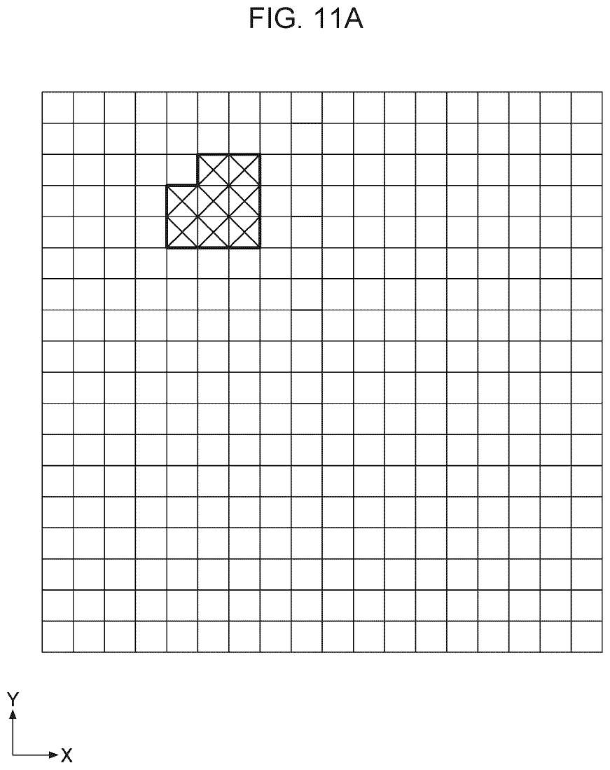

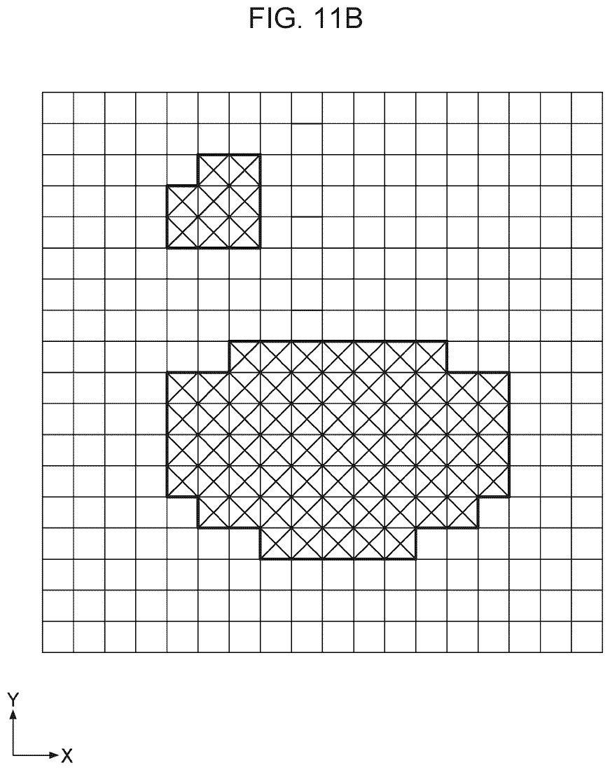

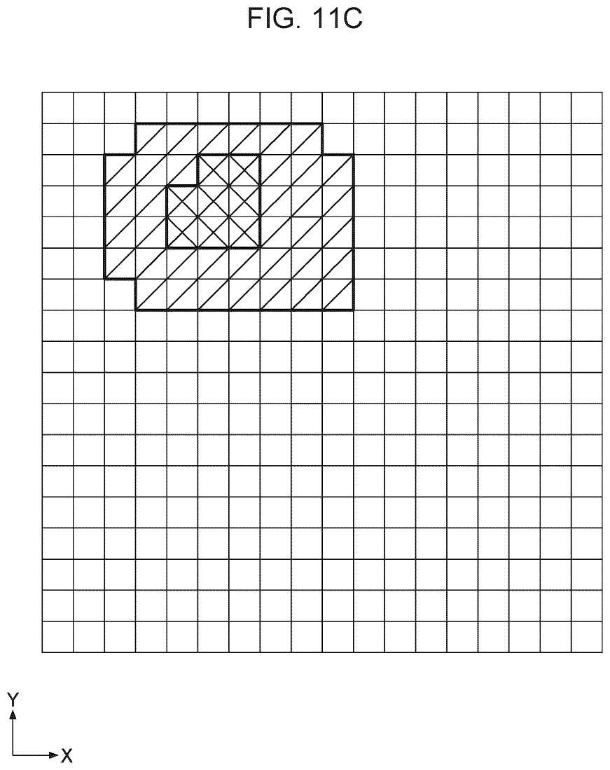

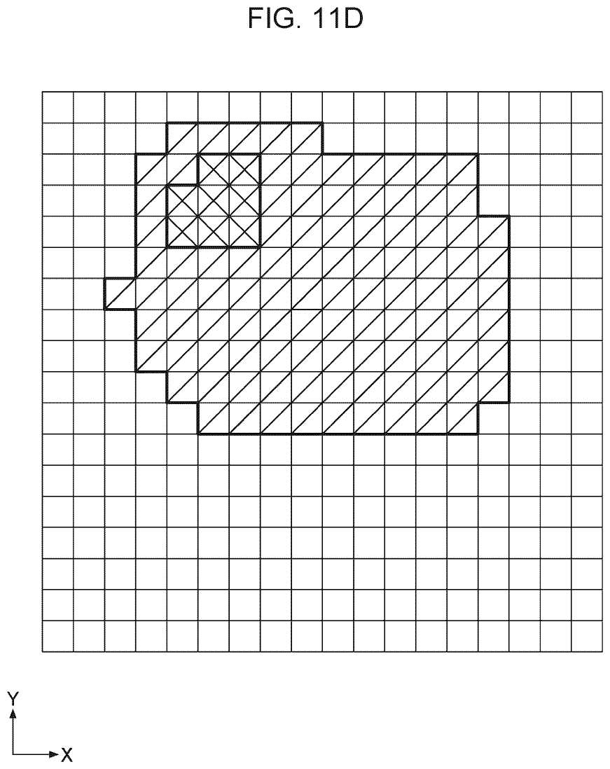

FIG. 11A to FIG. 11D illustrate examples of the distribution of capacitances detected by the electrostatic sensor 120. In FIG. 11A to FIG. 11D, as an example, the points at which the sensor electrodes 121X and 121Y intersect in plan view are 18 in the X direction and 18 in the Y direction, and the electrostatic sensor 120 is capable of detecting capacitances at 18×18 points, that is, 324 detection points. Accordingly, FIG. 11A to FIG. 11D illustrates 324 frames, 18 rows by 18 columns.

In addition, detection points at which the capacitances exceed the second threshold value TH2 illustrated in FIG. 4A to FIG. 4C are indicated by × marks, and detection points at which the capacitances exceed the first threshold value TH1 but less than or equal to the second threshold value TH2 are indicated by / marks. Detection points at which the capacitances are less than or equal to the first threshold value TH1 are not indicated by × marks and / marks but are indicated in white.

In FIG. 11A, there are eight × marks and no / marks in the upper left part. These × marks are, as an example, detection points at which the hand H is in the contact state, and the number of detection points is less than 12, which is the determination number threshold value.

Accordingly, the electrostatic coordinate input device 100 determines that the pointing operation in the contact state is being performed. The coordinates of the pointing operation in the contact state correspond to the position of the detection point with the largest capacitance among the eight detection points indicated by the × marks.

In FIG. 11B, there are 8 × marks in the upper left part and 64 / marks in the lower part of the center. These × marks are, as an example, detection points at which the hand His in the contact state, and the number of detection points exceeds 12, which is the determination number threshold value. Accordingly, the electrostatic coordinate input device 100 determines that the non-pointing operation in the contact state is being performed. The coordinates of the non-pointing operation in the contact state correspond to the position of the detection point with the largest capacitance among the 72 detection points indicated by the x marks.

In FIG. 11C, there are 8 × marks in the upper left part and 37 / marks around the × marks. In FIG. 11C, these × marks are, as an example, detection points at which the hand His in the confirmation state, and the number of detection points is less than 90, which is the determination number threshold value. Accordingly, the electrostatic coordinate input device 100 determines that the pointing operation in the confirmation state is being performed. The coordinates of the pointing operation in the confirmation state correspond to the position of the detection point with the largest capacitance among the eight detection points indicated by the × marks.

In FIG. 11D, there are 8 × marks in the upper left part and 100 / marks around the × marks. In FIG. 11D, these × marks are, as an example, detection points at which the hand His in the confirmation state, and the number of detection points exceeds 90, which is the determination number threshold value. Accordingly, the electrostatic coordinate input device 100 determines that the non-pointing operation in the confirmation state is being performed. The coordinates of the non-pointing operation in the confirmation state correspond to the position of the detection point with the largest capacitance among the eight detection points indicated by the x marks.

### <Example Operation of Electrostatic Coordinate Input Device 100>

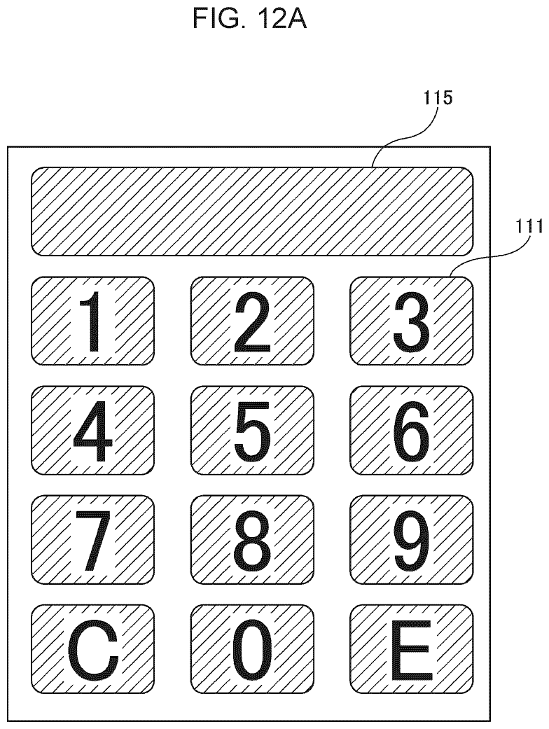

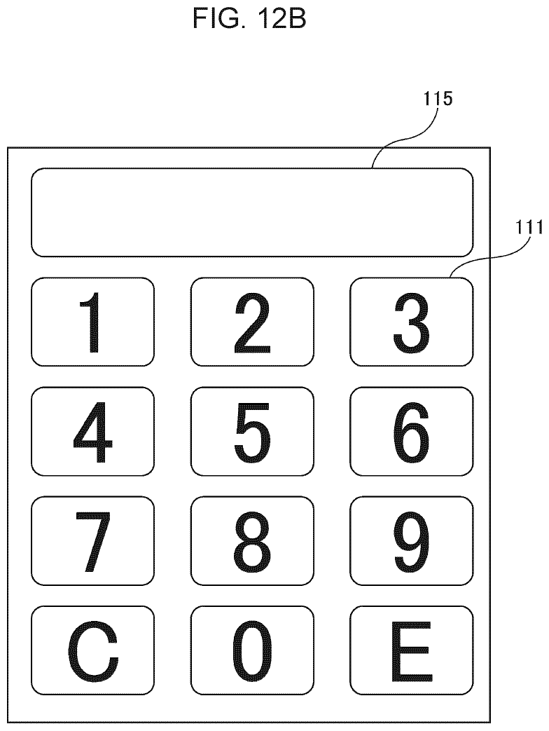

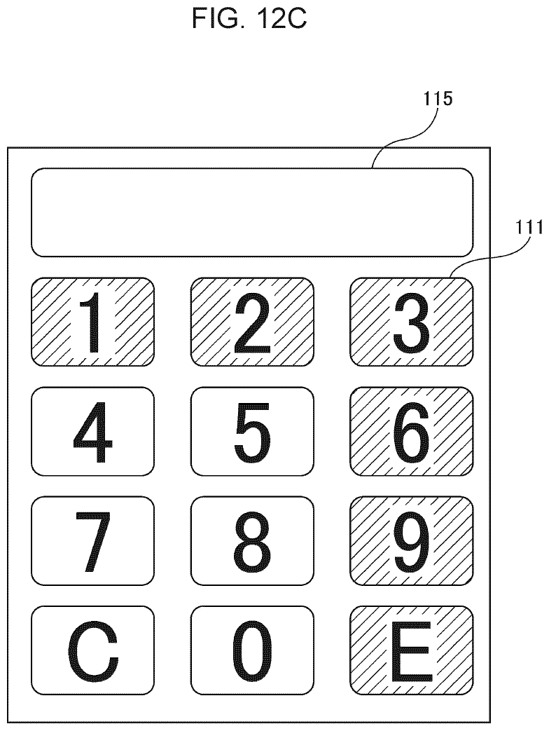

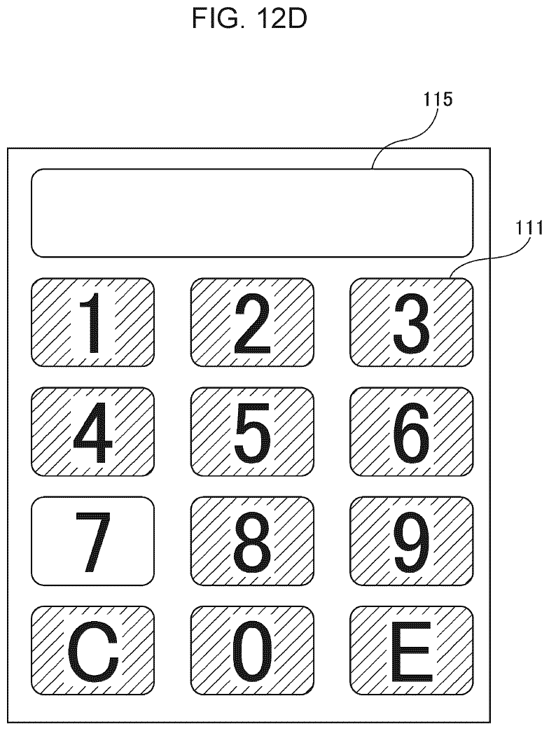

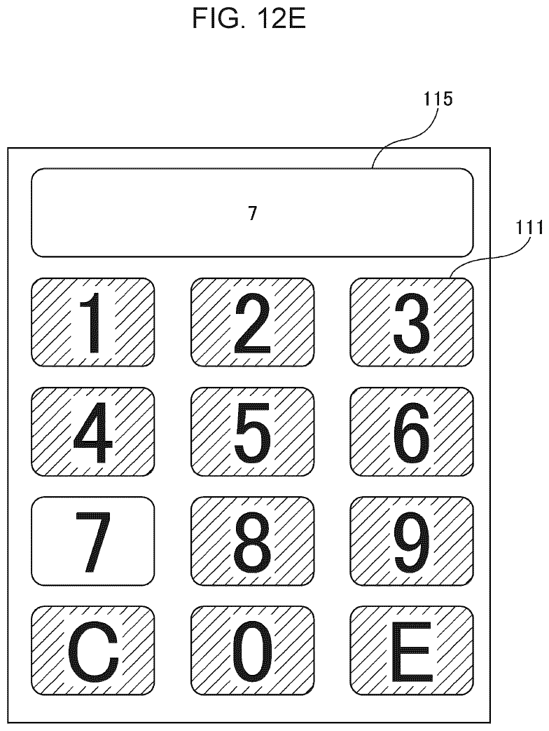

FIG. 12A to FIG. 12E illustrate an example operation of the electrostatic coordinate input device 100. A case in which the pointing operation is performed will be described with reference to FIG. 12A to FIG. 12E. FIG. 12A to FIG. 12E illustrate the numeric keypad part and the input content display section 115 of the electrostatic coordinate input device 100 illustrated in FIG. 1 in a simplified manner.

In FIG. 12A, the electrostatic coordinate input device 100 is in a standby state, and the backlight is turned off and the numeric keypad part and the input content display section 115 are dark. In FIG. 12A, the distance state is the undetected state.

In FIG. 12B, the hand H is moved toward the operation surface 105A and the distance state is the proximity state. In the proximity state, the electrostatic coordinate input device 100 is switched from the standby state to an active state, and the backlight is turned on for all keys and the input content display section 115. The backlight that is turned on illuminates the numeric keypad part and the input content display section 115.

In FIG. 12C, the hand H is further moved toward the operation surface 105A and the distance state is the selection state. As an example, the fingertip FT is positioned above the key 7, and the backlight is turned on for the key 7 and the keys 4, 5, 8, C, and 0 around the key 7 and is turned off for the other keys.

In FIG. 12D, the hand H is further moved toward the operation surface 105A and the distance state is the confirmation state. As an example, the fingertip FT is positioned above the key 7, and the backlight is turned on only for the key 7 to which the operation has been confirmed and is turned off for the other keys. Accordingly, the user can visually recognize that the operation to the key 7 has been confirmed. In FIG. 12D, the user is holding the hand H with respect to the operation surface 105A at the position described with reference to FIG. 12D and waiting for the operation to be confirmed, and the distance state is the confirmation state.

In FIG. 12E, the user is holding the hand H with respect to the operation surface 105A at the position described with reference to FIG. 12D and the operation has been confirmed. The fingertip FT is positioned above the key 7, and in response to the confirmation of the operation, “7” is displayed on the input content display section 115.

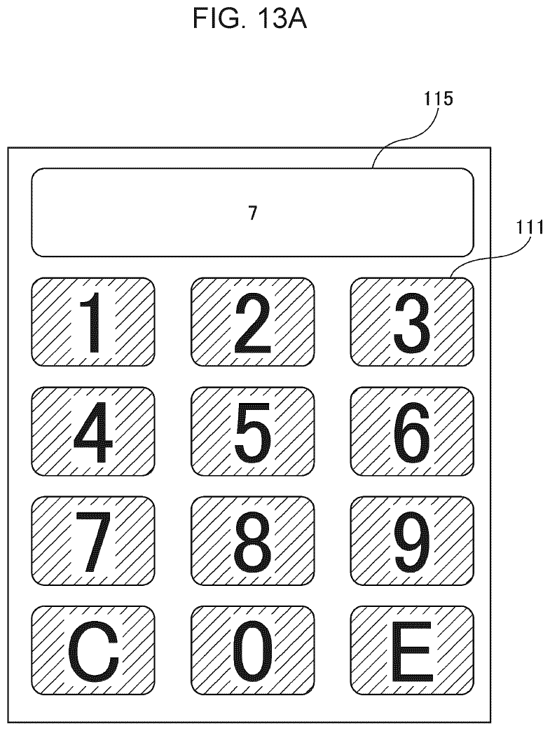

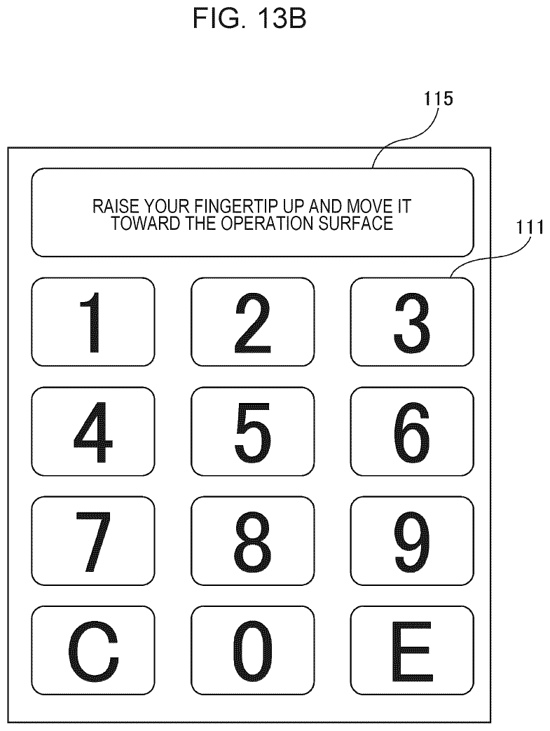

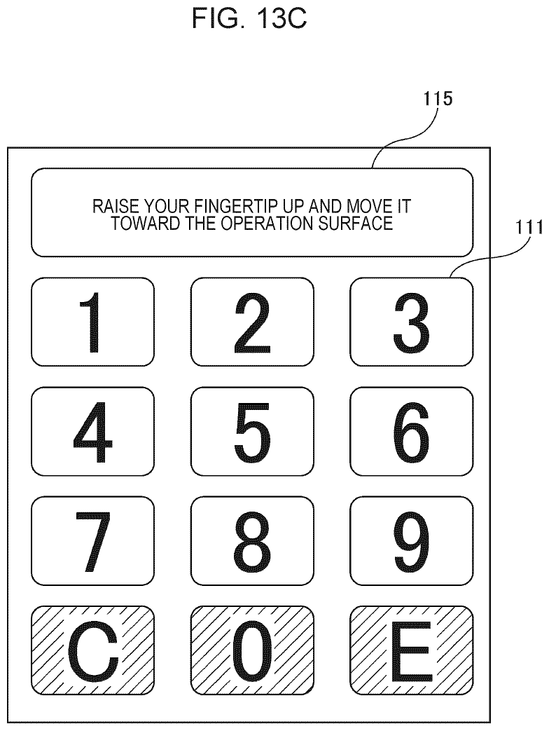

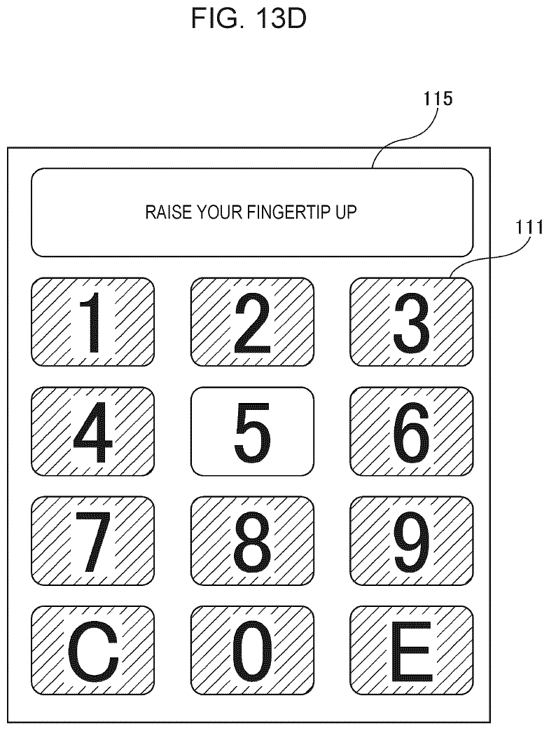

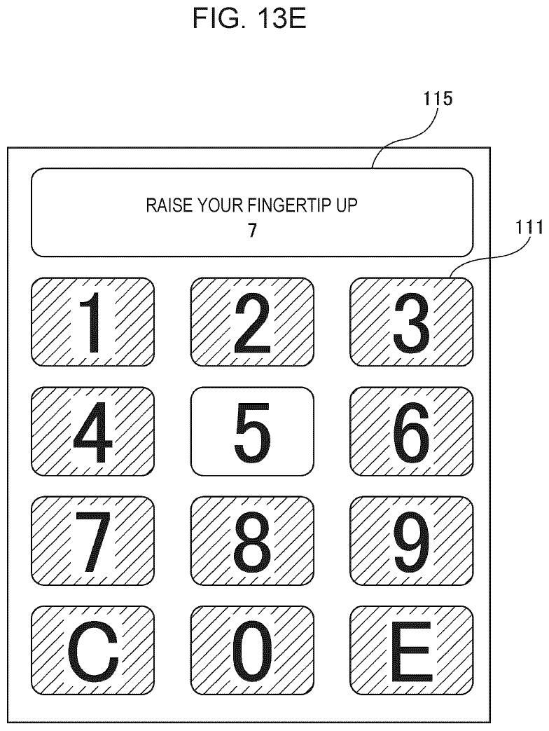

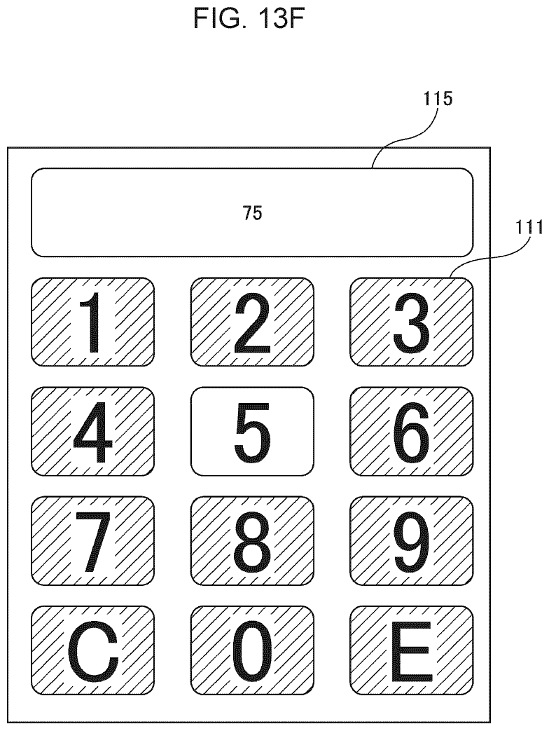

FIG. 13A to FIG. 13F illustrate an example operation of the electrostatic coordinate input device 100. With reference to FIG. 13A to FIG. 13F, a case will be described in which, after an input of the numeral 7 is confirmed as described with reference to FIG. 12E, the hand His moved sufficiently away from the operation surface 105A, and the non-pointing operation illustrated in FIG. 4C is performed. In the non-pointing operation illustrated in FIG. 4C, the fingertip FT is positioned at an angle with respect to the operation surface 105A and the palm is also moved toward the operation surface 105A. FIG. 13A to FIG. 13F illustrate the numeric keypad part and the input content display section 115 of the electrostatic coordinate input device 100 illustrated in FIG. 1 in a simplified manner.

In FIG. 13A, the distance state is the undetected state and in the electrostatic coordinate input device 100, the backlight is turned off for the numeric keypad and is turned on for the input content display section 115 to display the input content.

In FIG. 13B, the hand H in the non-pointing operation is moved toward the operation surface 105A and the distance state is the proximity state. When the distance state is changed to the proximity state, the electrostatic coordinate input device 100 turns on the backlight for all keys and the input content display section 115, and since the electrostatic coordinate input device 100 has detected that the non-pointing operation is being performed, a warning message “Raise your fingertip up and move it toward the operation surface” is being displayed on the input content display section 115. This message is intended to prompt the user to perform the pointing operation.

In FIG. 13C, the hand H in the non-pointing operation is further moved toward the operation surface 105A and the distance state is the selection state. As an example, although there is a largest capacitance on the key 5, the operation is the non-pointing operation, and thus the backlight is turned on for the key 7 and the keys 4, 5, 8, C, and 0 around the key 7 and is turned off for the other keys.

In FIG. 13D, the hand H is further moved toward the operation surface 105A and the distance state is the confirmation state. As an example, the fingertip FT is positioned above the key 5, and the backlight is turned on only for the key 5 and is turned off for the other keys. In this state, the fingertip FT is still positioned at an angle, and the warning message “Raise your fingertip up and move it toward the operation surface” is displayed on the input content display section 115.

FIG. 13E illustrates a state in which the state illustrated in FIG. 13D continues and the time required to confirm the operation has elapsed, but this operation is the non-pointing operation and thus the operation has not been confirmed. In this state, the fingertip FT is still positioned at an angle, and the warning message “Raise your fingertip up and move it toward the operation surface” is displayed on the input content display section 115.

FIG. 13F illustrates a state in which the fingertip FT is raised with respect to the operation surface 105A from the state described with reference to FIG. 13E. The operation is confirmed by raising the fingertip FT, and “5” is displayed on the input content display section 115 in addition to “7”.

### <Effect>

The electrostatic coordinate input device 100 includes the operation surface 105A, a plurality of sensor electrodes 121X and 121Y disposed on a back side of the operation surface 105A, the measurement circuit (AD conversion unit 132 and other components) configured to measure a capacitance of each of the plurality of sensor electrodes 121X and 121Y, and the calculation unit 134 configured to calculate a position of an operation body based on the plurality of capacitances measured by the measurement circuit (AD conversion unit 132 and other components). The calculation unit 134 calculates a largest capacitance between the operation body and the sensor electrodes 121X and 121Y based on the plurality of capacitances, based on the largest capacitance, sets a non-pointing determination threshold value used to determine a non-pointing operation that is not a pointing operation of the operation body, and when the number of capacitances exceeding the non-pointing determination threshold value among the plurality of capacitances exceeds a determination number threshold value, determines that the operation of the operation body is the non-pointing operation.

By setting a non-pointing determination threshold value based on a largest capacitance, the cross-sectional area at a position a certain distance away from the operation surface 105A can be measured with respect to a position closest to the operation surface 105A in the hand H. In other words, when a cross-sectional area at a position a few centimeters away from the fingertip FT has a predetermined size or greater, it is considered that a non-pointing operation in which the operation surface 105A is not pointed is being performed. Even in the non-contact state, by accurately determining a state in which the operation surface 105A is not pointed, incorrect operations can be prevented.

Accordingly, the electrostatic coordinate input device 100 capable of accurately determining, depending on the distance from an operation body, whether a contact operation, a proximity operation, or the like is being performed and thereby preventing incorrect operations can be provided.

Based on the largest capacitance, the calculation unit 134 sets a pointing determination threshold value used to determine that the operation of the operation body is a pointing operation, and when the number of capacitances exceeding the pointing determination threshold value among the plurality of capacitances is less than or equal to the determination number threshold value, determines that the operation of the operation body is the pointing operation. Accordingly, the pointing operation can be determined accurately.

Based on the largest capacitance, the calculation unit 134 determines whether a distance between the operation body and the operation surface 105A corresponds to any of a plurality of distance states, the non-pointing determination threshold value, the pointing determination threshold value, and the determination number threshold value are set for each of the plurality of distance states, and the non-pointing determination threshold values are set to larger values as the distances represented by the plurality of distance states become shorter.

Accordingly, an appropriate non-pointing determination threshold value can be readily set, and the electrostatic coordinate input device 100 capable of accurately determining, depending on the distance from an operation body, whether an operation such as a contact operation, a proximity operation, or the like is being performed and thereby preventing incorrect operations can be provided.

The plurality of distance states include a contact state in which the operation surface 105A and the operation body are in contact with each other and a plurality of non-contact states in which the operation surface 105A and the operation body are not in contact with each other, the non-pointing determination threshold value in the contact state is larger than the non-pointing determination threshold values in the plurality of non-contact states, the pointing determination threshold value in the contact state is larger than the pointing determination threshold values in the plurality of non-contact states, and the determination number threshold value in the contact state is smaller than the determination number threshold values in the plurality of non-contact states. In the contact state, a contact area is used to determine whether a pointing operation or a non-pointing operation is performed. In other words, the determination is made by using an area in contact with the operation surface 105A, and thus by using the non-pointing determination threshold value and the pointing determination threshold value larger than the non-pointing determination threshold values and the pointing determination threshold values in the non-contact state, the determination accuracy can be increased. In addition, by using the determination number threshold value in the contact state smaller than the determination number threshold values in the plurality of non-contact states, the determination accuracy can be increased.

The pointing determination threshold values in the plurality of non-contact states are equal to each other, and the determination number threshold values in the plurality of non-contact states are equal to each other. This configuration is particularly useful when the non-pointing operation is detected and an operation method that requires an operation of releasing the hand H from the operation surface 105A once is applied.

The plurality of non-contact states include, from shorter to longer distances represented by the plurality of distance states, a confirmation state in which an input content is confirmed, a selection state in which an input candidate is selected, a proximity state in which the operation body is close to the input candidate, and an undetected state in which the operation body is not detected, the non-pointing determination threshold value in the undetected state and the non-pointing determination threshold value in the proximity state are the same value, and the pointing determination threshold value in the undetected state and the pointing determination threshold value in the proximity state are the same value, and the determination number threshold value in the undetected state and the determination number threshold value in the proximity state are the same value. Accordingly, it is possible to simultaneously perform the detection of the hand H and the detection of the non-pointing operation when the state changes to the proximity state.

The calculation unit 134, in a state in which the operation of the operation body has been determined to be the pointing operation, when a state in which the number of the capacitances exceeding the non-pointing determination threshold value exceeds the determination number threshold value stands consecutively for a predetermined number of times, determines that the operation of the operation body is the non-pointing operation, in a state in which the operation of the operation body has been determined to be the pointing operation, until a state in which the number of the capacitances exceeding the non-pointing determination threshold value exceeds the determination number threshold value stands consecutively for a predetermined number of times, determines that the operation of the operation body is the non-pointing operation, in a state in which the operation of the operation body has been determined to be the non-pointing operation, when a state in which the number of the capacitances exceeding the pointing determination threshold value is less than or equal to the determination number threshold value stands consecutively for a predetermined number of times, determines that the operation of the operation body is the pointing operation, and in a state in which the operation of the operation body has been determined to be the non-pointing operation, until a state in which the number of the capacitances exceeding the pointing determination threshold value is less than or equal to the determination number threshold value stands consecutively for a predetermined number of times, determines that the operation of the operation body is the non-pointing operation. This configuration effectively prevents incorrect detections due to noise.

A display unit (input content display section 115) is further provided, and in a state in which the operation of the operation body has been determined to be the non-pointing operation, the calculation unit 134 displays, on the display unit (input content display section 115), a message requesting that the pointing operation be performed with the operation body. Accordingly, it is possible to guide the user to perform a correct operation by performing a pointing operation by raising the fingertip FT, preventing incorrect operations.

A method of determining an operation method in an electrostatic coordinate input device including the operation surface 105A, a plurality of sensor electrodes 121X and 121Y disposed on a back side of the operation surface 105A, the measurement circuit (AD conversion unit 132 and other components) configured to measure a capacitance of each of the plurality of sensor electrodes 121X and 121Y, and the calculation unit 134 configured to calculate a position of an operation body based on the plurality of capacitances measured by the measurement circuit (AD conversion unit 132 and other components) is provided. The method includes calculating a largest capacitance between the operation body and the sensor electrodes 121X and 121Y based on the plurality of capacitances, based on the largest capacitance, setting a non-pointing determination threshold value used to determine a non-pointing operation that is not a pointing operation of the operation body, and when the number of capacitances exceeding the non-pointing determination threshold value among the plurality of capacitances exceeds a determination number threshold value, determining that the operation of the operation body is the non-pointing operation.

By setting a non-pointing determination threshold value based on the largest capacitance, a cross-sectional area at a position a certain distance away from the operation surface 105A can be measured with respect to a position closest to the operation surface 105A in the hand H. In other words, when a cross-sectional area at a position a few centimeters away from the fingertip FT has a predetermined size or greater, it is considered that a non-pointing operation in which the operation surface 105A is not pointed is being performed. Even in the non-contact state, by accurately determining a state in which the operation surface 105A is not pointed, incorrect operations can be prevented.

Accordingly, a method of determining an operation in an electrostatic coordinate input device capable of accurately determining, depending on the distance from an operation body, whether a contact operation, a proximity operation, or the like is being performed can be provided.

### <Modifications>

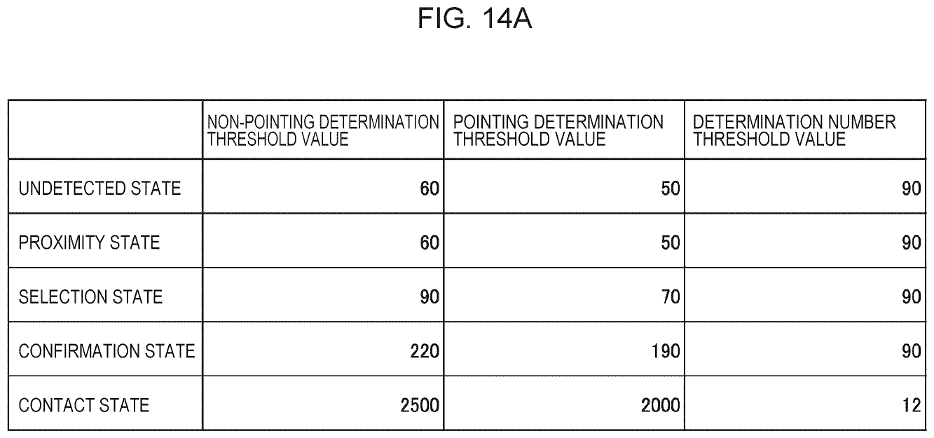

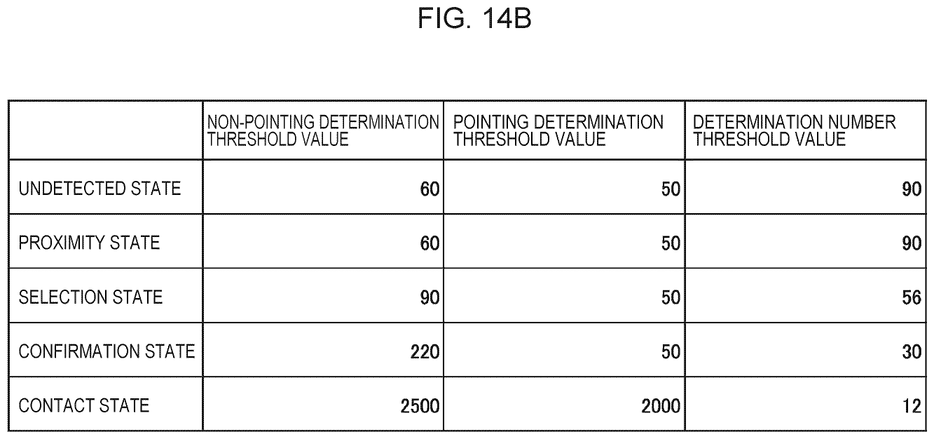

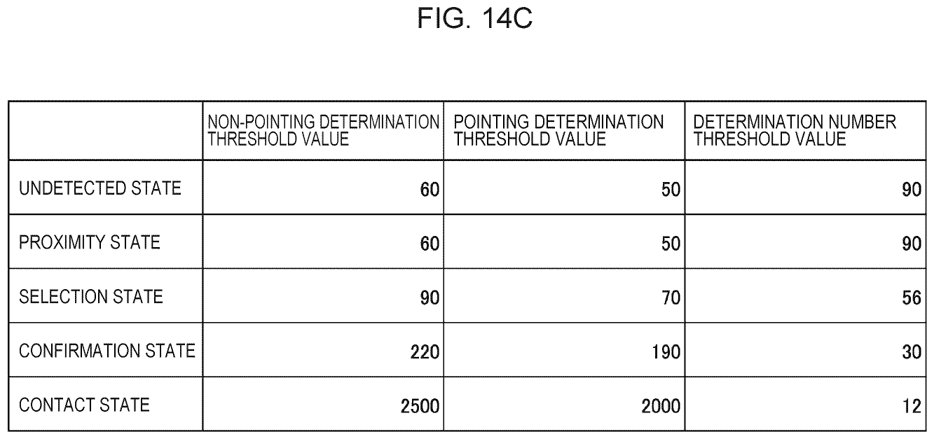

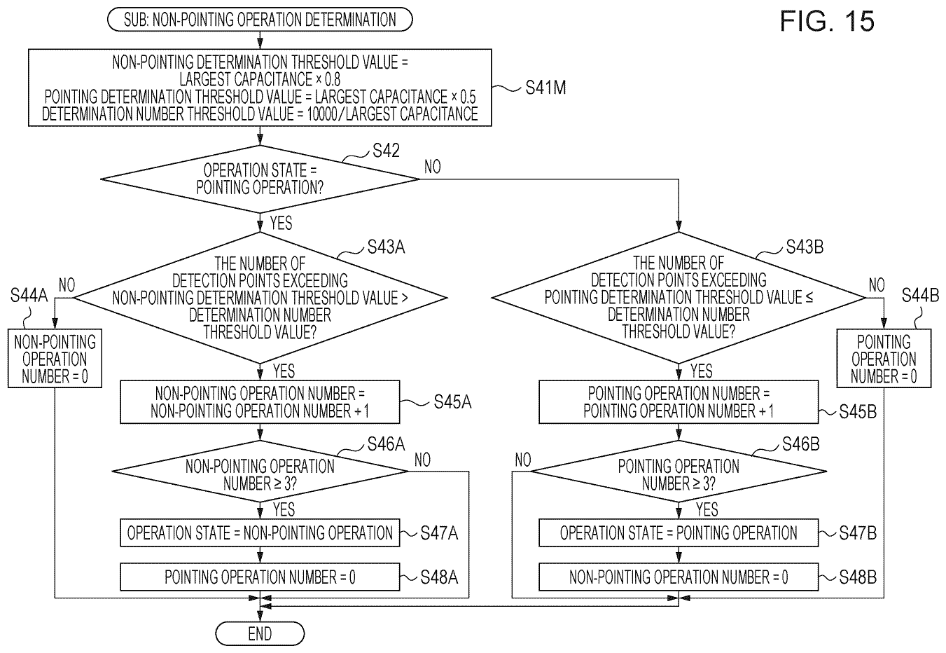

FIG. 14A to FIG. 14C illustrate modifications of the table data of threshold values to be used in the non-pointing operation determination processing.

In the table data illustrated in FIG. 14A, the determination number threshold values in the plurality of non-contact states are equal to each other, and the pointing determination threshold values in the plurality of non-contact states become larger as the distances represented by the plurality of distance states become shorter.

More specifically, compared with the table data in FIG. 9, the pointing determination threshold values in the selection state and the confirmation state are large and are set to 70 and 190 respectively. With these larger pointing determination threshold values in the selection state and the confirmation state, the state can be returned to the undetected state without releasing the hand H from the operation surface 105A.

In the table data illustrated in FIG. 14B, the pointing determination threshold values in the plurality of non-contact states are equal to each other, and the determination number threshold values in the plurality of non-contact states become smaller as the distances represented by the plurality of distance states become shorter.

More specifically, compared with the table data in FIG. 9, the determination number threshold values in the selection state and the confirmation state are small and are set to 56 and 30 respectively. In other words, as states change from the contact state through the confirmation state, the selection state, the proximity state, to the undetected state, the determination number threshold values are set to become larger. Accordingly, as the hand H moves away from the operation surface 105A, it is possible to determine whether the pointing operation or the non-pointing operation is being performed in a state in which a cross-sectional area is large.

In the table data illustrated in FIG. 14C, the pointing determination threshold values become larger and the determination number threshold values become smaller as the distances represented by the plurality of distance states become shorter. More specifically, this data structure is a combination of the table data illustrated in FIG. 14A and FIG. 14B.

More specifically, compared with the table data in FIG. 9, the pointing determination threshold values in the selection state and the confirmation state are large and are set to 70 and 190 respectively. In addition, the determination number threshold values in the selection state and the confirmation state are small and are set to 56 and 30 respectively.

Accordingly, with these larger pointing determination threshold values in the selection state and the confirmation state, the state can be returned to the undetected state without releasing the hand H from the operation surface 105A. In addition, as the hand H moves away from the operation surface 105A, it is possible to determine whether the pointing operation or the non-pointing operation is being performed in a state in which a cross-sectional area is large.

FIG. 15 is a flowchart illustrating a modification of the non-pointing operation determination processing. In the flowchart illustrated in FIG. 15, the processing in step S41 in the flowchart of the non-pointing operation determination processing illustrated in FIG. 10 is replaced with the processing in step S41M. The processing after step S42 is the same as in the flowchart of the non-pointing operation determination processing illustrated in FIG. 10. Accordingly, here, the processing in step S41M is described.

The calculation unit 134 sets a non-pointing determination threshold value to a value obtained by multiplying a largest value of the capacitances detected by the electrostatic sensor 120 in the control cycle by a coefficient 0.8, sets a pointing determination threshold value to a value obtained by multiplying the largest value of the capacitances detected by the electrostatic sensor 120 in the control cycle by a coefficient 0.5, and sets a determination number threshold value to a value obtained by dividing 10000 by the largest value of the capacitances detected by the electrostatic sensor 120 in the control cycle (step S41M).

In other words, the non-pointing determination threshold value is a value proportional to a largest capacitance. Note that the coefficient for multiplying a largest capacitance is not limited to 0.8, and may be set to an appropriate value. The pointing determination threshold value is a value proportional to a largest capacitance. Note that the coefficient for multiplying a largest capacitance is not limited to 0.5 and is a value smaller than a coefficient for multiplying a non-pointing determination threshold value, and may be set to an appropriate value. In other words, the pointing determination threshold value is a value larger than a non-pointing determination threshold value. The determination number threshold value is a value inversely proportional to a largest capacitance. Accordingly, a non-pointing operation can be determined without using the table data of the threshold values illustrated in FIG. 9 and FIG. 14A to FIG. 14C.

Although the electrostatic coordinate input device and the method of determining an operation in an electrostatic coordinate input device according to the exemplary embodiments of the disclosure have been described above, it is to be understood that the disclosure is not limited to these embodiments disclosed specifically, and various modifications or changes may be made without departing from the scope of the claims.

1. An electrostatic coordinate input device comprising:
an operation surface on which an operation body performs an operation, the operation being a pointing operation or a non-pointing operation which is not the pointing operation;
a plurality of sensor electrodes disposed on a back side of the operation surface;
a measurement circuit configured to measure a capacitance between the operation body and the sensor electrode at each of the plurality of sensor electrodes, thereby outputting a plurality of measured capacitances; and
a calculation unit configured to determine a position of the operation body based on the plurality of measured capacitances,
wherein the calculation unit is further configured to:
calculate a largest capacitance from the plurality of measured capacitances;
set a non-pointing determination threshold for the non-pointing operation based on the largest capacitance; and
determine that the operation being performed by the operation body is the non-pointing operation when a number of measured capacitances, among the plurality of measured capacitances, which exceed the non-pointing determination threshold exceeds a determination number threshold.

2. The electrostatic coordinate input device according to claim 1, wherein the calculation unit is further configured to:
set a pointing determination threshold for the pointing operation; and
determine that the operation being performed by the operation body is the pointing operation when a number of measured capacitances, among the plurality of measured capacitances, which exceed the pointing determination threshold is equal to or smaller than the determination number threshold.

3. The electrostatic coordinate input device according to claim 2, wherein the calculation unit is further configured to:
determine, based on the largest capacitance, whether a distance between the operation body and the operation surface corresponds to any of a plurality of distance states, each distance state representing a distance from the operation surface; and
set the non-pointing determination threshold, the pointing determination threshold, and the determination number threshold for each of the plurality of distance states, such that the smaller the distance represented by the distance state, the greater the non-pointing determination threshold for the distance state.

4. The electrostatic coordinate input device according to claim 3,
wherein the plurality of distance states include:
a contact state in which the operation surface and the operation body are in contact with each other; and
a plurality of non-contact states in which the operation surface and the operation body are not in contact with each other,
and wherein the non-pointing determination threshold for the contact state is set greater larger than that for each of the plurality of non-contact states, the pointing determination threshold for the contact state is set greater than that for each of the the plurality of non-contact states, and the determination number threshold for the contact state is set smaller than that for each of the plurality of non-contact states.

5. The electrostatic coordinate input device according to claim 4,
wherein the pointing determination threshold for each of the plurality of non-contact states has a same value, and the determination number threshold for each of the plurality of non-contact states has a same value.

6. The electrostatic coordinate input device according to claim 4,
wherein the determination number threshold for each of the plurality of non-contact states has a same value, and the smaller the distance represented by the distance state in the non-contact state, the grater the pointing determination threshold for the non-contact state.

7. The electrostatic coordinate input device according to claim 4,
wherein the pointing determination threshold for each of the plurality of non-contact states has a same value, and the smaller the distance represented by the distance state corresponding to the non-contact state, the smaller the determination number threshold for the non-contact state.

8. The electrostatic coordinate input device according to claim 4,
wherein the smaller the distance represented by the distance state, the greater the pointing determination threshold and the smaller the determination number threshold.

9. The electrostatic coordinate input device according to claim 4,
wherein the plurality of non-contact states include, in a decreasing order of the distance represented by the distance state:
an undetected state in which the operation body is not detected;
a proximity state in which the operation body is moved toward an input candidate on the operation surface;
a selection state in which the input candidate is selected; and
a confirmation state in which an input content is confirmed,
and wherein the non-pointing determination threshold for the undetected state and the non-pointing determination threshold for the proximity state have a same value, the pointing determination threshold for the undetected state and the pointing determination threshold for the proximity state have a same value, and the determination number threshold for the undetected state and the determination number threshold for the proximity state have a same value.

10. The electrostatic coordinate input device according to claim 2, wherein the non-pointing determination threshold is proportional to the largest capacitance.

11. The electrostatic coordinate input device according to claim 10, wherein the pointing determination threshold is proportional to the largest capacitance and is larger than the non-pointing determination threshold.

12. The electrostatic coordinate input device according to claim 10, wherein the determination number threshold is inversely proportional to the largest capacitance.

13. The electrostatic coordinate input device according to claim 2, wherein the calculation unit is further configured to:
after making a determination that the operation of the operation body is the pointing operation, change the determination into the non-pointing operation when the number of the measured capacitances exceeding the non-pointing determination threshold has exceeded the determination number threshold a predetermined number of times consecutively, while maintaining the determination of the pointing operation until the number of the measured capacitances exceeding the non-pointing determination threshold has exceeded the determination number threshold the predetermined number of times consecutively; and
after making a determination that the operation of the operation body is the non-pointing operation, change the determination into the pointing operation when the number of the measured capacitances exceeding the pointing determination threshold has been equal to or smaller than the determination number threshold a predetermined number of times, while maintaining the determination of the non-pointing operation until the number of the measured capacitances exceeding the pointing determination threshold has been or equal to or smaller than the determination number threshold the predetermined number of times.

14. The electrostatic coordinate input device according to claim 13, further comprising a display unit,
wherein the calculation unit is further configured to, when the operation of the operation body has been determined to be the non-pointing operation, display, on the display unit, a message requesting that the pointing operation be performed with the operation body.

15. A method for determining an operation performed by an operation body on an operation surface of an electrostatic coordinate input device, the operation being a pointing operation or a non-pointing operation which is not the pointing operation, the electrostatic coordinate input device having a plurality of sensor electrodes disposed on a back side of the operation surface, the method comprising:
measuring a capacitance between the operation body and the sensor electrode at of each of the plurality of sensor electrodes, thereby obtaining a plurality of measured capacitances;
calculating a largest capacitance and a position of the operation body based on the plurality of measured capacitances;
setting a non-pointing determination threshold for the non-pointing operation based on the largest capacitance; and
determining that the operation being performed by the operation body is the non-pointing operation when a number of measured capacitances, among the plurality of measured capacitances, which exceed the non-pointing determination threshold exceeds a determination number threshold.

16. The method according to claim 15, further comprising:
setting a pointing determination threshold for the pointing operation; and
determining that the operation being performed by the operation body is the pointing operation when a number of measured capacitances, among the plurality of measured capacitances, which exceed the pointing determination threshold is equal to or smaller than the determination number threshold.
